(19) United States
(12) Patent Application Publication
(10) Pub. No.: US 2006/0262367 A1
(43) Pub. Date: Nov. 23, 2006

(54) Authentication recording medium and medium and authentication recording medium producting method

(76) Inventors: Ryoji Hattori, Tokyo (JP); Shigehiro Kitamura, Tokyo (JP)

Correspondence Address: LUCAS & MERCANTI, LLP, 475 PARK AVENUE SOUTH, 15TH FLOOR, NEW YORK, NY, 10016, US

(21) Appl. No.: 10/545,960

(22) PCT Filed: Feb. 17, 2004
(86) PCT No.: PCT/JP04/01736

§ 371 Date: Aug. 16, 2005

(30) Foreign Application Priority Data
Feb. 20, 2003 (JP) JP2003-042309

(51) Int. Cl. G02B 5/32

(52) U.S. Cl. 359/15

(57) ABSTRACT

An authentication recording-medium, comprising a substrate for the authentication recording-medium having a center line average roughness (Ra) of 0.5 to 80.0 μm: a substrate light scattering preventing layer provide on the substrate; and a hologram provided on the substrate light scattering preventing layer. With the above structure, it can be possible to provide an authentication recording-medium in which an adhesion capability with a hologram can be made well without spoiling an appearance of a hologram and falsification and modification can be made difficult.

### TECHNICAL FIELD

The present invention relates to authentication recording medium and method of producing the authentication recording medium suitable for personal authentication card or personal authentication sheet, such as driver's license and passport, that stores or records information including personal information and is required of high security including forgery preventive characteristic or falsification preventive characteristic.

### BACKGROUND OF ART

These days, since personal information including photograph of face is recorded on personal ID card, passport, alien registration certificate, library user's card, cash card, credit card, license card such as driver's license, worker ID card, employee ID card, member card, clinic service card, student ID card, and some other certificates, special security processing has been provided for prevention of easy forgery or falsification in the field of service industries such in public agencies, banks, enterprises, medical establishments and schools. In addition, since the personal information such as photography of face itself is formed on the surface of these authentication recording media in many cases for the sake of identification, there are available those that can be-produced in a large quantity and quickly, 2 6337 and at the same time can ensure improved falsification/modification preventive characteristic and durability. (For example, see the Patent Document 1, Patent Document 2, and Patent Document 3.)

[Patent Document 1] Japanese Application Patent Laid-open Publication No. HEI 6-282214 (1994) (pp. 1-4, FIGS. 1-5)

[Patent Document 2] Japanese Application Patent Laid-open Publication No. HEI 5-69690 (1993) (pp. 1-12, FIGS. 1-12)

[Patent Document 3] Japanese Application Patent Laid-open Publication No. 2001-293983 (pp. 1-30, FIGS. 1-26)

The Patent Document 1 discloses a method of producing a Lippmann type hologram and certificates using the hologram. However, the forgery preventive characteristic is poor because the adhesion of hologram on a paper substrate is poor and so it can be peeled off easily. In addition, when a Lippmann type hologram is adhered on a paper substrate, the appearance of the hologram degrades because of the surface quality of the paper substrate.

In the Patent Document 2, UV-curable coating liquid is applied on the image forming surface of the substrate containing an intermediate protecting layer and the applied UV-curable coating liquid is set by irradiation of UV light, and thereby card type recording medium protected by the UV-curing resin layer via the intermediate protecting layer is produced in a large quantity and quickly, ensuring improved fixation and durability of image. However, the UV-curable coating liquid cannot be applied on the substrate evenly and it maintainability was low.

In the Patent Document 3, after a transfer foil comprising at least a bonding layer, high-refractive index layer, scale pigment layer and transparent resin layer in this order is transferred onto an information carrier layer with backing by a heat roll, the backing of the transfer foil is peeled off so as to form a protecting layer made of UV-curing layer. However, there is a problem that the production equipment is complicated, production requires long time, and production cost is high.

### DISCLOSURE OF THE INVENTION

The present invention, which is made in view of the above problems, mounts a special substrate scattering protecting layer (base member scattering protection layer) on an authentication recording medium having a specific Ra, thereby ensuring good appearance and satisfactory adhesion of hologram. In addition, the invention enables easy maintenance, speedy production and reduction of production equipment size, and hence lower production cost.

An object of the present invention is to offer an authentication recording medium and a method of producing the authentication recording medium that ensures good appearance of hologram and satisfactory adhesion of hologram and also is extremely difficult to falsification or modification (forge or falsify).

(1) In order to achieve the above objective, an embodiment of the present invention is an authentication recording medium made of the substrate of an authentication recording medium having the center-line average roughness (Ra) of 0.5 to 80.0 μm on which a substrate light-scattering preventing layer of 0.3 to 100 μm thick is formed and further a hologram layer is formed thereon.

(2) The present invention is an authentication recording medium as set forth in (1) above, wherein a face image recording layer or personal information recording layer is formed on the substrate of the authentication recording medium, the substrate light-scattering preventing layer is formed on the face image recording layer or personal information recording layer, and furthermore the hologram layer is formed thereon.

(3) The present invention is an authentication recording medium as set forth in (2) above, wherein the face image recording layer or personal information recording layer is formed by either one or more of the (a) sublimation recording method, (b) melting recording method, and (c) transfer recording method.

(4) The present invention is an authentication recording medium as set, forth in (2) above, wherein the face image recording layer or personal information recording layer is formed by the sublimation recording method.

(5) The present invention is an authentication recording medium as set forth-in (4) above, wherein two or more types of sublimation color having different absorption wavelengths are used in the sublimation recording method.

(6) Another embodiment of the present invention is a method of producing authentication recording medium comprising a recording layer forming process for forming a face image recording layer or personal information recording layer on the first image receiving sheet by at least one of the (a) sublimation recording method and (b) melting recording method; then a substrate scattering light preventing layer forming process for forming a substrate light-scattering preventing layer of 0.3 to 100 μm thick; then the first transfer process for transferring the face image recording layer or personal information recording layer and substrate light-scattering preventing layer, both formed on the first image receiving sheet, onto the substrate of the authentication recording medium having the center-line average roughness (Ra) of 0.5 to 80.0 μm; and then a process for forming a hologram layer on the substrate of the authentication recording-medium.

(7) The present invention is a method of producing authentication recording medium as set forth in (6) above, which includes the second transfer process for transferring the hologram layer from the second image receiving sheet having the hologram layer onto the substrate of the authentication recording medium.

(8) The present invention is a method of producing authentication recording medium as set forth in (6) above, which includes a process for forming the hologram layer on the second image receiving sheet, and then the second transfer process for transferring the hologram layer recorded and formed on the second image receiving sheet onto the substrate of the authentication recording medium.

(9) The present invention is a method of producing authentication recording medium as set forth in (7) or (8) above, wherein the second transfer process includes a recording process for recording optional information on the second image receiving sheet with either one or more recording materials of (a) sublimation color, (b) melting ink, (d) fluorescence agent, (e) IR-light absorbing agent, (f) pearl pigment, and (g) optical variable device; a bonding layer forming process for forming a bonding layer; and then a transfer process for transferring the information and bonding layer formed on the second image receiving sheet onto the substrate of the authentication recording medium.

(10) The present invention is a method of producing authentication recording medium as set forth in (7) to (9) above, wherein the second image receiving sheet includes a photo-curing layer.

(11) The present invention is a method of producing authentication recording medium as set forth in (9) or (10) above, wherein the recording material contains metallic ion contained compound that reacts with thermo-diffusing pigment and forms chelate.

(12) The present invention is a method of producing authentication recording medium as set forth in (6) to (12) above, wherein the substrate of the authentication recording medium is paper.

### BRIEF DESCRIPTION OF THE DRAWINGS

FIGS. 1(a) and 1(b) are schematic diagrams of a substrate of an authentication recording medium according to the first example of the invention.

FIGS. 2(a) to 2(h) are schematic structural diagrams of a substrate of a face image recording layer or a personal information record forming material according to the first example of the invention.

FIGS. 3(a) to 3(h) are schematic structural diagrams of a substrate of a face image recording layer or a personal information record forming material according to the first example of the invention.

FIG. 4 is a schematic structural diagram of an authentication recording medium paper substrate adhesive layer forming material according to the first example of the invention.

FIGS. 5(a) to 5(c) are schematic structural diagrams of an image receiving sheet according to the first example of the invention.

FIGS. 6(a) to 6(g) are schematic structural diagrams of a falsification and modification preventing layer forming material according to the first example of the invention.

FIGS. 7(a) to 7(g) are schematic structural diagrams of a falsification and modification preventing layer forming material according to the-first example of the invention.

FIG. 8 is a schematic structural diagram of the surface of an authentication recording medium formed by the first example of the invention.

FIG. 9 is a schematic structural diagram of the surface of an authentication recording medium formed by the first example of the invention.

FIG. 10 is a schematic structural diagram of the surface of an authentication recording medium formed by the first example of the invention.

FIG. 11 is a schematic structural diagram of the surface of an authentication recording medium formed by the first example of the invention.

FIG. 12 is a schematic structural diagram of the surface of an authentication recording medium formed by the first example of the invention.

FIG. 13 is a schematic structural diagram of the surface of an authentication recording medium formed by the first example of the invention.

FIG. 14 is a schematic structural diagram of the surface of an authentication recording medium formed by the first example of the invention.

FIG. 15 is a schematic structural diagram of the surface of an authentication recording medium formed by the first example of the invention.

FIG. 16 is a schematic structural diagram of the surface of an authentication-recording medium formed by the first example of the invention.

FIG. 17 is a schematic structural diagram of the surface of an authentication recording medium formed by the first example of the invention.

FIG. 18 is a schematic structural diagram of an authentication recording medium issuing apparatus to produce an authentication recording medium.

FIG. 19 is a schematic structural diagram of an authentication recording medium issuing apparatus to produce an authentication recording medium.

FIG. 20 is a schematic structural diagram of an authentication recording medium issuing apparatus to produce an authentication recording medium.

FIG. 21 is a schematic structural diagram of an authentication recording medium issuing apparatus to produce an authentication recording medium.

FIG. 22 is a schematic structural diagram of an authentication recording medium issuing apparatus to produce an authentication recording medium.

FIG. 23 is a schematic structural diagram of an authentication recording medium issuing apparatus to produce an authentication recording medium.

### THE BEST MODE FOR CARRYING OUT THE PRESENT INVENTION

The construction of the present invention is described hereunder in detail.

<Substrate of Authentication Recording Medium>

Material used for the substrate of the authentication recording medium is optional, and the substrate can be a card, sheet or leaflet for the convenience sake of personal authentication substrated on document or personal information. Paper substrate is used most frequently for data page of the leaflet type, and paper is the most preferable for the substrate of the authentication recording medium of the present invention. Paper is made mainly from vegetable fiber by beating and stirring in water to entwine with each other and then by dewatering and drying, wherein the strength between fibers is attained by hydrogen bond of the hydroxyl radicals of cellulose in the material. In case of paper mixed with others than vegetable fiber, such as synthetic fiber, magnetic metallic fiber or fluorescent thread, binder is needed in most cases because bonding force like hydrogen bond is not generated between synthetic fibers. Accordingly, the mixture ratio of synthetic fiber and amount of binder shall be so determined appropriately as not to lose paper strength. Since the special treatment like the above strengthens the forgery or falsification preventive characteristic of the paper substrate itself, it is employed preferably in this invention.

Additives used for paper include clay, talc, calcium carbonate, and titanium dioxide; sizing agents include rosin, alkyl ketene dimer, stealic acid anhydride, alkenyl succinic acid anhydride, and wax; and paper strengtheners include denatured starch, polyvinyl alcohol, polyalkyl amide, urea-formaldehyde, melamine-formaldehyde, and polyethylene imine. These agents are added respectively in mixing process and paper is manufactured mainly on a fourdrinier paper machine, but not limited thereto. Normal method of manufacturing paper can be employed. That is, fibers swelled sufficiently in water solution having the material density of 0.1 to 5%, preferably 0.3 to 0.6% are mixed well and spread over wire screen or mesh, and paper is complete after water is drained and moisture is removed by heating.

In addition to the above paper material, other synthetic resins such as polyethylene terephthalate film, polypropylene film, polyvinyl chloride, polyester, polycarbonate, polymethyl methacrylate, and polystyrene, natural resins and/or synthetic papers can be employed independently or in combination as composite. One containing IC chip between the data page and back surface is also applicable.

The effect of the present invention is produced when at least either one of the layers of the substrate has the center-line average roughness (Ra) of 0.5 to 80.0 μm. If it exceeds 80.0 μm, there arises a problem that the authentication recording layer degrades, for example, quality of photograph of face degrades. If it is less than 0.5 μm, there arises a problem that the paper loses its special characteristic and falsification/modification preventive characteristic degrades.

The center-line average roughness (Ra) of the invention is measured by Kosaka Laboratories' surface roughness tester (Surfcorder SE-30D).

<Substrate Light-Scattering Preventing Layer>

The substrate light-scattering preventing layer (which may be called the bonding layer of paper substrate of authentication recording medium or simply the bonding layer in this invention) means a substrate light-scattering preventing layer on which an authentication recording medium having specific Ra is so mounted as to maintain good appearance of hologram and to provide excellent adhesion with hologram, and is preferred to have bonding capability with paper substrate of the authentication recording medium.

Because the hologram layer employs a technique utilizing a phenomenon caused by different refractive indexes, appearance of the hologram degrades if the reflection light, compared to the incident light, scatters due to the roughness of the substrate. In particular, reflection light is very much important on a volumetric type hologram, the appearance may tremendously degrade.

Material for the substrate light-scattering preventing layer can be any of known thermoplastic resin. For example, thermoplastic resin including ethylene-vinyl acetate copolymer, polyvinyl acetate, polyvinyl alcohol, polyester, polyamide, polyvinyl butyral, polyethylene, polypropylene, phenoxy resin, epoxy resin, and acrylic resin; rubber including natural rubber, polybutadiene rubber, styrene-butadiene rubber, chloroprene rubber, acrylonitrile-butadiene rubber, nitrile rubber, urethane rubber, and silicone rubber; thermoplastic elastomer including styrene type thermoplastic elastomer such as polystyrene-polybutadiene-polystyrene block copolymer (SBS), SEBS added with polybutadiene of the SBS by hydrogen, and polystyrene-polyisoprene-polystyrene block copolymer (SIS), polyolefin type thermoplastic elastomer, polyurethane type thermoplastic elastomer, polyester type thermoplastic elastomer, and polyamide type thermoplastic elastomer; and so-called adhesion adder such as fatty acid type hydrocarbon resin, rosin type resin, and terpine type resin can be used independently or in mixture. Heat sensitizing adhesion type material is preferred in this invention.

In addition to the above thermoplastic resin, hot-melt adhesive is also applicable. Hot-melt adhesive can be ethylene-vinyl acetate copolymer (EVA) type, polyester type, polyamide type, thermoplastic elastomer type, and polyolefin type. However, since the substrate is paper in this invention and so warp is caused on the paper substrate when adhered at a high temperature, heat sensitizing adhesion layer (substrate light-scattering preventing layer) that can be adhered at a low temperature is preferred.

To be concrete, a reaction type hot-melt adhesive is more preferable among-the low-temperature adhesives. Light-curing adhesive or moisture-curing-adhesive, or elastic epoxy adhesive is more preferable.

Reaction type hot-melt adhesive using moisture-curing type material is disclosed in the Japanese Application Patent Laid-open Publication Nos. 2000-036026, 2000-219855, 2000-211278, and 2002-175510. Light-curing adhesive is disclosed in the Japanese Application Patent Laid-open -Publication Nos. HEI 5-125330 (1993), HEI 7-82544 (1995), HEI 9-125010 (1997), HEI 10-316959 (1998), HEI 11-116903 (1999), and HEI 11-140414 (1999).

Moisture-curing adhesive, for example, is mainly made of urethane polymer having isocyanate radical on its molecular edge, where the isocyanate radical reacts with water to form a bridge. Reaction type adhesive applicable to this invention includes TE030, TE100 manufactured by Sumitomo 3M, Hybon 4820 manufactured by Hitachi Chemical, Bond Master 170 Series manufactured by Kanebo NSC, Macroplast QR 3460 manufactured by Henkel, and Esdyne 9631 manufactured by Sekisui Chemical. Use of resins having different elasticity is preferable in this invention. By using resins having different elasticity, resin having higher elasticity exhibits a skeleton function and resin having lower elasticity flows as filling fluid in adhering the backing to help increase smoothness. In addition, since the above generates a so-called beam in the composition, durability against deformation improves. When using moisture-curing type adhesive, one having free MDI of less than 1.0% is preferable in view of the safety of material.

Light-curing adhesive, for example, has a function that it is hot-melted by heat to achieve adhesion with the substrate and then radical or cation is generated by light to accelerate bridging and improve the aggregation of the light-curing layer.

Light-curing adhesive includes Double Tack tape manufactured by Sekisui Chemical and Lux Track manufactured by Toa Gosei.

It is permissible to use any of the above thermoplastic resin, thermoplastic elastomer and hot-melt adhesive.

The effect of the present invention is obtained when the substrate light-scattering preventing layer (heat sensitizing adhesion layer) is 0.3 to 100 μm, and 10 to 80 μm is particularly preferable. If the film thickness is less than 0.3 μm, there arises a problem that sufficient adhesion of the backing cannot be expected and so the appearance of the hologram degrades. If it exceeds 100 μm there arises a problem that the strength of the authentication recording medium itself changes and so conveyance inside a handling machine becomes unsmooth.

Depending upon the purpose of the substrate, the adhesive may be used together with color, organic and inorganic pigment, oxygen remover or reducer such as phosphine, phosphonate, phosphite, discoloration inhibitor, halation preventive agent, fluorescent whitening agent, coloring agent, extender, plasticizer, flame retarder, oxidant inhibitor, photo-stabilizer, UV absorber, low-refractive index agent, high-refractive index agent, leveling agent, oxidant inhibitor, anti-mildew agent, magnetic substance and other additives and solvents for adding various properties, or it is also permissible to add the above as an independent layer close to the substrate if necessary.

<Additive Component>

Any component other than the above can be added to the substrate light-scattering preventing layer as needed so far as the object of the present invention is not hindered. For example, heat melting ink layer can contain fluorine surface active agent. Contained fluorine surface active agent prevents blocking-of the heat melting ink layer. In addition, adding organic fine particle, inorganic fine particle or non-compatible resin is effective to improve the sharpness of image containing transferred character information and clearness of character profile.

<Method of Forming Substrate Light-Scattering Preventing Layer>

The substrate light-scattering preventing layer can be made either by forming the substrate light-scattering preventing layer onto the backing by hot-melt extrusion or by dispersing and dissolving adhesive components into suitable organic solvent and then applying it on the substrate and drying. If necessary, a peeling layer may be provided between the substrate and substrate light-scattering preventing layer. A low-refractive index lay may additionally be provided to improve the substrate light-scattering preventive characteristic.

Of the various types of thermoplastic resins listed above, preferable thermoplastic resin used as the component of the peeling layer in this invention is the one of which melting point or softening point is normally in a range of 50 to 150° C. and particularly in a range of 60 to 120° C. or ones which fall within the range when two or more are used in mixture. The peeling layer may contain coloring agent as needed. Preferable thickness of the peeling layer shall be 0.0001 to 4 μm, and more preferably 0.0005 to 2.5 μm.

<Method of Forming Adhesive Sheet for Substrate Light-Scattering Prevention>

The adhesive sheet for substrate light-scattering prevention can be formed by preparing the coating liquid for forming an ink layer for substrate light-scattering prevention in which each component of the substrate light-scattering preventing layer is dispersed or dissolved and then applying and drying it. If necessary, the coating liquid for forming an ink layer for substrate light-scattering prevention in which each component of the substrate light-scattering preventing layer is dispersed or dissolved is applied and dried after the peeling layer described above is formed.

<Method of Forming Substrate Light-Scattering Preventing layer>

The transfer method using the above adhesive sheet for substrate light-scattering prevention is to melt the substrate light-scattering preventing layer by heat and transfer it. It is not different from a normal heat sensitive transfer recording. The description below is a case where a thermal head, the most typical heat source is employed. The substrate light-scattering preventing layer of the adhesive sheet for substrate light-scattering prevention is put closely onto the print face of the image receiving layer to begin with, and then heat pulse is applied to the substrate light-scattering preventing layer by thermal head so as to heat part of the substrate light-scattering preventing layer corresponding to the transfer pattern.

The temperature of the heated part of the substrate light-scattering preventing layer increases, and is quickly softened and transferred onto the print surface of the image receiving layer of the substrate. Preferable width of the transferred surface shall be any and is not limited so far as the appearance of the hologram to be provided thereon is-not hindered.

In this invention, it is preferred that the image receiving layer, face image recording layer or personal information recording layer of the image receiving sheet described hereunder and the adhesive sheet for substrate light-scattering prevention are put together and pressurized in a range of 0.3 to 0.01 kg/cm² in accordance with transfer recording signal under a head temperature of 50 to 500° C., preferably 100 to 500° C. or 100 to 400° C. so as to form the layer on the image receiving layer or face image recording layer of the image receiving sheet. More preferable pressure is 0.25 to 0.01 kg/cm², and further more preferable is 0.25 to 0.02 kg/cm².

Another method applicable to this invention is that the adhesive sheet for substrate light-scattering prevention and the paper substrate of the authentication recording medium are put together beforehand and pressurized in a range of 0.3 to 0.01 kg/cm² in accordance with transfer recording signal under a head temperature of 50 to 500° C., preferably 100 to 500° C. or 100 to 400° C. so as to transfer the adhesive sheet for substrate light-scattering prevention onto the paper substrate of the authentication recording medium. More preferable pressure is 0.25 to 0.01 kg/cm², and further more preferable is 0.25 to 0.02 kg/cm².

If necessary, light source may be employed so as to improve the aggregation of the adhesion layer of the substrate for light-scattering prevention or adhesion with the substrate, which can be either before or after transferring onto the paper substrate of the authentication recording medium without any limitation.

Activation light can be, for example, laser, light-emitting diode, xenon flash lamp, halogen lamp, carbon arc lamp, metal halide lamp, tungsten lamp, mercury lamp, HV mercury lamp, and electrodeless light source. Preferable light source is xenon lamp, halogen lamp, carbon arc lamp, metal halide lamp, tungsten lamp, and mercury lamp. The energy added by the above can be suitably selected by adjusting the exposure distance, time and intensity depending upon the type of polymerization initiator. In using the activation light, it is permissible to shut out the air by nitrogen displacement or vacuuming to accelerate the polymerization. If laser is used as the light source, exposure area can be reduced to the smallest possible size, and so high resolution image can be formed. Preferably applicable laser light source includes argon laser, He—Ne laser, YAG laser and semiconductor laser. In this invention, metal halide lamp, tungsten lamp, mercury lamp and HV mercury lamp are preferred because of lower cost.

<Face Image Recording Layer or Personal Information Recording Layer>

In the present invention, a face image recording layer or personal information recording layer is recorded on the paper substrate for the authentication recording medium. “Format print layer” It is preferred that the authentication recording substance of the present invention shall be so formed that character information and face image elements comprising multiple-information carriers consisting of face image recording layer or personal information recording layer are provided on a paper substrate for the authentication recording medium or on a paper substrate for the authentication recording medium on which the format print layer has already been formed.

In the present invention, a format printing layer may be formed on an authentication recording medium paper substrate in advance.

The format printing layer represents at least one selected from plural layers recording identification information and booklet information, specifically, represents a ruled line, a company name, a card name, remarks, a publishing agency telephone number, etc.

The format printing layer is provided on an authentication recording medium paper substrate by a printing method such as a resin typographic printing, a planographic printing, a silk screen printing, a flexography, and a screen printing.

To protect against forgery by visual inspection, a water-mark printing, a hologram, a fine-line printing can be used in the format printing layer of the present invention. The forgery/alteration preventive layer can be selected appropriately according to the printed matter, hologram, barcode, matte pattern, fine-line, background pattern and concavo-convex pattern. A visible light absorbing coloring material, ultraviolet absorber, infrared-absorber, fluorescent whitening agent, glass deposited layer, bead layer, optical change element layer, pearl ink layer, phosphorus flake pigment layer can be used.

The information carrying member formed by format printing can be produced by commonly used ink listed in the “Planographic printing technology”, “A compendium of new printing technology”, “Offset printing technology”, “An Illustrated guide to prepress processing and printing” by the Japan Association for Printing technologies. Carbon and other ink, in addition to photocurable ink, oil-soluble ink and solvent type ink are used for the formation.

The authentication recording medium-according to the invention can be structured by plural information carrying members such as a face image recording layer or a personal information recording layer and can be provided with character information and face image elements.

In the case of a face image, the full-color image having a gradation is produced, for example, by the sublimation heat transfer method or silver halide color photographic method. The text information is made of a binary image. It is produced by fusion thermal transfer recording method, sublimation heat transfer method, silver halide color photographic method, electrophotographic method, inkjet method or re-transfer method. In the present invention, a recognition-identification image such as a face image and an attribute information image are produced preferably by the fusion thermal transfer recording method, sublimation heat transfer method, and inkjet method, more preferably by sublimation heat transfer method.

<a. Sublimation Type Thermal (Thermal) Transfer Recording Method>

It is preferred that the face image recording layer, that is, gradation image layer is formed by the sublimation type thermal transfer recording method by which image appears favorably as a photographic image. It is preferable that the sublimation type thermal transfer recording pigment applicable to this method contains a layer that can receive image and post chelate pigment such as thermal diffusion pigment that can form chelate. If necessary, falsification or modification pattern and personal information layer may be formed by the sublimation type thermal transfer recording method.

In forming a falsification or modification pattern, where different thermal diffusion colors are used for example to generate a gradation image or character information of which difference cannot be recognized visually, a technique for sensing and recognizing the difference in wavelength by a spectrometer may be employed. The difference can be recognized by a method that reads the pattern on a scanner for sensing specific wavelength and picks up an image of specific wavelength.

In this invention, the face image recording layer or personal information recording layer can be provided directly on the authentication recording medium, utilizing the below mentioned sublimation type thermal transfer recording sheet. It is more preferable in this invention to employ a method in which an intermediate transfer medium is formed by providing a peeling layer on a backing made of resin such as polyethylene terephthalate and further providing a transferable image receiving layer made of resin having dying property thereon and then the image is transferred again onto the authentication recording medium. This method of transferring again is more effective than direct printing by which the surface quality (center-line average roughness Ra) of the authentication recording medium is low and sharpness degrades. Preferable peeling layer is made of hydrophilic resin such as gelatin and heat melting material such as natural wax, of which detail will be described later. Preferable resin forming the transferable image receiving layer is the same as the ones listed later as preferable for the image receiving layer.

<Sublimation Type Thermal Transfer Recording Ink Sheet>

The sublimation type thermal transfer recording ink sheet may be formed by a well-known structure. That is, in the sublimation type thermal transfer recording ink sheet, a thermal diffusible dye containing ink layer is usually formed on a support.

<Support>

As a support for the sublimation type thermal transfer recording ink sheet, any sheet may be used as far as it has a good dimensional stability and a resistance for heat at the time of recording with a thermal head, concretely, a film or a sheet described at lines 12-18 in a lower left column of page 2 of Japanese Patent Unexamined publication No. 63-193886. As a thickness of the support, 1 to 10 μm may be preferable. The support member may have an undercoated layer for improving the adhesion with the binder and for avoiding transfer of the pigment to the support member side of the ink sheet or dyeing of the support member side by the pigment. Further, the reverse side of the support member (the side opposite to the thermal diffusible dye containing ink layer) may be provided with a sticking preventive layer in order to avoid fusion or sticking of the head to the ink sheet bundle and to prevent the sublimation transfer ink sheet from being wrinkled. The sticking preventive layer normally have a thickness of 0.1 through 1 μm.

<Thermal Diffusible Dye>

As a thermal diffusible dye, a conventionally well known thermal diffusible dye may be used, and for example, cyan dye, magenta dye and yellow dye may be employed. The aforementioned cyan pigment includes the naphtoquinone, anthraquinone and azomethine pigments disclosed in the Japanese Patent Tokkaisho 59-78896, the Japanese Patent Tokkaisho 59-227948, the Japanese Patent Tokkaisho 60-24966, the Japanese Patent Tokkaisho 60-53563, the Japanese Patent Tokkaisho 60-130735, the Japanese Patent Tokkaisho 60-131292, the Japanese Patent Tokkaisho 60-239289, the Japanese Patent Tokkaisho 61-19396, the Japanese Patent Tokkaisho 61-22993, the Japanese Patent Tokkaisho 61-31292, the Japanese Patent Tokkaisho 61-31467, the Japanese Patent Tokkaisho 61-35994, the Japanese Patent Tokkaisho 61-49893, the Japanese Patent Tokkaisho 61-148269, the Japanese Patent Tokkaisho 62-191191, the Japanese Patent Tokkaisho 63-91288, the Japanese Patent Tokkaisho 63-91287 and the Japanese Patent Tokkaisho 63-290793.

The aforementioned magenta pigment includes the anthraquinone, azo and azomethine pigments disclosed in the Japanese Patent Tokkaisho 59-78896, the Japanese Patent Tokkaisho 60-30392, the Japanese Patent Tokkaisho 60-30394, the Japanese Patent Tokkaisho 60-253595, the Japanese Patent Tokkaisho 61-262190, the Japanese Patent Tokkaisho 63-5992, the Japanese Patent Tokkaisho 63-205288, the Japanese Patent Tokkaisho 64-159, and the-Japanese Patent Tokkaisho 64-63194. The aforementioned yellow pigment includes the methine, azo, quinophthalone and anthraisothiazole pigments disclosed in the Japanese Patent Tokkaisho 59-78896, the Japanese Patent Tokkaisho 60-27594,-the Japanese Patent Tokkaisho 60-31560, the Japanese Patent Tokkaisho 60-53565, the Japanese Patent Tokkaisho 61-12394, and the Japanese Patent Tokkaisho 63-122594.

The particularly preferred sublimable pigment includes the azomethine pigment obtained by the reaction of coupling between a compound having an activated methylene group of open chain or closed chain with the oxidant of p-phenylene derivative or the oxidant of p-aminophenol derivative; and the indoaniline pigment obtained by the reaction of coupling between the compound having an activated methylene group of open chain or closed chain with the oxidant of the phenol or naphthol derivative or p-phenylene diamine derivative or the oxidant-of the p-aminophenol derivative.

A thermal diffusible dye contained in the ink layer can be any one of yellow, magenta and cyan dye if the image to be formed is monochromatic. Depending on the color tone of the image to be formed, any two or more of the aforementioned three dyes or other thermal diffusible dye may be contained.

<Binder>

Binder for the thermal diffusion pigment contained ink layer includes cellulose type resin such as ethyl cellulose, hydroxy ethyl cellulose, ethyl hydroxy ethyl cellulose, hydroxy propyl cellulose, methyl cellulose, cellulose acetate, and aceto-butyric acid cellulose; vinyl type resin such as polyvinyl alcohol, polyvinyl formal, polyvinyl butyral, polyvinyl pyrrolidone, polyester, polyvinyl acetate, polyacryl amide, polyvinyl aceto-acetal, styrene resin, styrene copolymer resin, ester polyacrylate, polyacrylate, and acrylate acid copolymer; rubber type resin; ionomer resin; and olefin type resin.

Of these resins, polyvinyl butyral, polyvinyl aceto-acetal, or cellulose type resin having superior acid resistance is preferable. Each of the above binders can be used independently or in mixture of two or more. Preferable weight ratio of the binder and thermal diffusion pigment is 1:10 to 10:1, particularly in a range of 2:8 to 8:2.

<Other Optional Components>

In addition to the above, other additives can be added to the thermal diffusion pigment contained ink layer so far as the object of the present invention is not hindered. Applicable additives are compound providing peeling property such as silicone resin, silicone oil (reaction curing type is also permissible), silicone denatured resin, fluorocarbon resin, surface active agent, and wax; filler such as metallic fine powder, silica gel, metallic oxide, carbon black, and resin fine powder; and hardener that can react with the binder components (for example, radiation active compound such as isocyanate, acryl, and epoxy). In addition, heat meltable material as additive for accelerating the transfer, such as wax and higher fatty acid ester, as disclosed in the Japanese Application Patent Laid-open Publication No. SHO 59-106997 (1984) is also included.

<Producing Ink Sheet for Sublimation Type Thermal Recording>

The ink sheet for sublimation type thermal recording can be produced by preparing the coating liquid for forming the thermal diffusion pigment contained ink layer by dispersing and dissolving each component for forming the thermal diffusion pigment contained ink layer into a solvent, and then applying it on the surface of the support and drying.

<Method of Sublimation Type Thermal Recording>

To form the face image recording layer or personal information recording layer, the thermal diffusion pigment contained ink layer of the ink sheet for sublimation type thermal transfer recording and the image receiving layer of the substrate are put together and then thermal energy is applied to the thermal diffusion pigment contained ink layer and image receiving layer image-wise. Then, the thermal diffusion pigment in the thermal diffusion pigment contained ink layer evaporates or sublimates by quantity corresponding to the thermal energy applied for forming an image and is transferred to the image receiving layer side. Thus, the image is received and an image containing gradation information is formed on the image receiving layer.

Thermal head is a typical heat source for applying thermal energy but other known sources such as laser beam, IR flash and thermal pen are also applicable. When a thermal head is employed as the heat source for applying thermal energy, the thermal energy to be applied can be varied continuously or in multiple steps by modulating the voltage or pulse width applied to the thermal head. When a laser beam is employed as the heat source for applying thermal energy, the thermal energy to be applied can be varied by varying the light quantity or irradiation area of the laser beam.

For smoother absorption of laser beam on this occasion, it is preferable to include laser beam absorbing material (for example, carbon black or near-IR absorbing material for semiconductor laser) in the ink layer or place it near the ink layer. When a laser beam is employed, the ink sheet for sublimation type thermal transfer recording and the image receiving layer of the substrate shall be put together thoroughly.

Using a dot generator integrated with acoustic-optical element enables to apply thermal energy in accordance with the size of halftone dot. When an IR flash lamp is employed as the heat source for applying thermal energy, it is preferable to apply heat through a color layer such as in black as in the case of using laser beam. Otherwise, heat may be applied via a black pattern or halftone dot pattern representing the gradation of the image continuously. It is also permissible to use a color layer for example all in black and a negative pattern equivalent to the negative image of the above pattern together for heating.

Heat can be applied either from the side of the ink sheet for sublimation type thermal transfer recording or from the side of the image receiving sheet for thermal transfer recording, or from both sides. If effective utilization of thermal energy is the most important, it is desirous to apply heat from the side of the ink sheet for sublimation type thermal transfer recording. While a monochrome image can be recorded on the image receiving layer of the image receiving sheet for thermal transfer recording as a result of the above thermal transfer recording, a color image with a color photograph touch containing various colors can be obtained by the following method. For example, a color image with a color photograph touch containing various colors can be produced if thermal sheets for thermal transfer recording corresponding to yellow, magenta, and cyan, and also black if necessary, are set one after another and heat transfer for each color is carried out.

A method below is also effective. That is to say, instead the thermal sheets for sublimation type thermal transfer recording corresponding to each color as above, an ink sheet for sublimation type thermal transfer recording provided with separate areas for each color is employed. A yellow-part image is heat-transferred first using the yellow area, and a magenta-part image is heat-transferred next using the magenta area, and then this is repeated one after another. Thus, a yellow-part, magenta-part, and cyan-part, and also black-part if necessary, is heat-transferred in turn.

After an image is formed by the above method, it is also permissible to further perform a heat treatment by the above-mentioned method for improving the image preservation. For example, it is permissible to perform heat treatment onto the whole surface of formed image by using a thermal head and utilizing the portions of the ink sheet for sublimation type thermal transfer recording on which thermal diffusion pigment contained ink layer is not provided or to perform another heat treatment by a heat roll. If near-IR absorbing agent is contained, it is permissible to expose the surface of formed image to IR flash lamp. Heating means is not specified in any case but, since this heat treatment is for the purpose of diffusing the pigment inside the image receiving layer, applying heat from the side of the support of the image receiving sheet is effective. Use of thermal head is preferred in this invention.

In the present invention, it is-preferable in forming an image that the image receiving sheet of thermal transfer recording and ink sheet for thermal transfer recording are put together and pressurized in a range of 0.3 to 0.01 kg/cm² in accordance with recording signal under a head temperature of 50 to 500° C., preferably 100 to 500° C. or 100 to 400° C. so as to form an image containing gradation information. More preferable pressure is 0.25 to 0.01 kg/cm², and further more preferable is 0.25 to 0.02 kg/cm².

<b. Method of Heat Melting Type Thermal Transfer Recording>

Use of the thermal transfer recording method is preferable for the personal information recording layer, that is, character information layer in order to maintain the sharpness, texture and density of characters.

<Ink Sheet for Heat Melting Type Thermal Transfer Recording>

The ink sheet for Heat Melting Type thermal transfer recording can be formed by laying a heat meltable layer on the support. The ink sheet for Heat Melting Type thermal transfer recording may contain another layer so far as its characteristic is not lost. For example, a peeling layer may be provided between the heat meltable ink layer and support, and also an intermediate layer may be provided between the peeling layer and the support. Furthermore, another layer may be provided on the heat meltable ink layer like an ink protecting layer on the most outer side. Furthermore, the above peeling layer or heat meltable ink layer can be of multiple layers if needed.

<Support>

It is desirous that the support of the ink sheet for Heat Melting Type thermal transfer recording shall have sufficient heat resistance as well as dimensional stability. The material can be for example a film or sheet disclosed in the Japanese Application Patent Laid-open. Publication No. SHO 63-193886 (1988), lines 12-18 in the lower left column on page 2. The thickness of the support is normally 30 μm and preferably in a range of 1 to 30 μm. If the thickness of the support exceeds 30 μm, thermal conductivity degrades, possibly resulting in degraded character quality. On a ink sheet for Heat Melting Type thermal transfer recording, the construction of the rear of the support is optional and so another support layer for mobile stability, anti-static charge or heat resistance may be provided.

<Heat Meltable Ink Layer>

The heat meltable ink layer may consist of heat meltable compound, thermoplastic resin and coloring agent, or of fluorescent pigment, pearl pigment, and IR absorbing color or pigment if necessary.

<Hot Melt Compound >

The hot melt compound normally used for the hot melt ink layer of the ink sheet for hot melt transfer recording of this type can be used freely as the aforementioned hot melt compound. To put it more specifically, such a hot melt compound can be exemplified by the thermoplastic resins of low molecular weight, including a polystyrene resin, acryl resin, styrene-acryl resin, polyester resin and polyurethane resin, as well as the substances listed in the 8th line on the upper left-hand section through the 12th line on the upper-left section of page 4 of the Japanese Patent Tokkaisho 63-193886. In addition, rosin, hydrogenated rosin, polymerized rosin, rosin modified glycerin, rosin modified maleic acid resin, rosin-modified polyester resin, rosin modified phenol resin, ester gum, and other rosin derivatives similar to them, as well as phenol resin, terpene resin, ketone resin, cyclopentadiene resin and aromatic hydrocarbon resin.

The hot melt compound is normally preferred to have a molecular weight of 5,000 or more without exceeding 10,000 and a melting point or softening point of 50 through 150 degrees Celsius. One of the hot melt compounds may be used independently or two or more of them may be used in combination.

<Thermoplastic Resin>

The aforementioned thermoplastic resin used as the component of the hot melt ink layer are found in great varieties, including the resin used on the hot melt ink layer of the hot melt transfer recording ink sheet of this type. It can be exemplified by the substances listed on the upper right-hand section of page 4 through the 18th line on the upper-left section of page 5 of the Japanese Patent Tokkaisho 63-193886.

<Coloring Agent>

The aforementioned coloring agent used as the component of the hot melt ink layer includes the one used on the hot melt ink layer of the hot melt transfer recording ink sheet of this type. It can be exemplified by the inorganic pigments and organic pigments as well as the organic dye listed in the 3rd line on the upper left-hand section through the 15th line of page 5 of the Japanese Patent Tokkaisho 63-193886. The coloring agents of this type may be used independently or two or more of them may be used in combination, as required.

<Fluorescent Agent>

Fluorescent color or fluorescent pigment may be either inorganic compound or organic compound, and no particular limitation is specified. However, when it is contained in a fluorescent layer, the particle size of the fluorescent color or fluorescent pigment is preferred to be smaller and normally is in a range of 0 to 2.0 μm, and more preferably in a range of 0 to 1.0 μm. It is preferable that none in solid phase is contained in a sensitized screen. Accordingly, fluorescent color or fluorescent pigment made from organic compound is preferred because of its small particle size and high quantum efficiency.

Fluorescent color or fluorescent pigment can be any known color or pigment, including colors and pigments described in “Coloring Handbook” (pp. 315-1109, Organic Compound Association, 1970) or “Color Technology Handbook” (pp. 225-417, Coloring Material Association, 1989). In particular, colors described in “Laser Dies” (by Mitsuo Maeda, Academic Press, 1984) are preferable. To be concrete, they are carbocyanine pigment listed in Table 4 on pages 26-29, phthalocyanine pigment listed in Table 11 on pages 74-75, xanthene pigment listed in Table 12 on pages 76-105, triaryl methane pigment listed in Table 13 on page 106, acrizine pigment listed in Table 14 on pages 107-110, condensed ring compound listed in Table 18 on pages 137-149, coumarin and azacoumarin pigment listed in Table 23 on pages 189-238, quinolon and azaquinolon pigment listed in Table 25 on pages 239-246, oxazole and benzo-oxazole compound listed in Table 26 on pages 247-261, furan and benzo-furan pigment listed in Table 29 on pages.273-275, pyrazoline compound listed in Table 30 on page 276, phthal-imide and naphthal-imide compound listed in Table 31 on page 277, peteridine compound listed in Table 32 on page 282, and pyrylium, phosphorine, borazi-azinium and pyridine compounds listed in Table 33 on page 283.

In addition, diketopirolo pyrrole compound described in the Japanese Application Patent Laid-open Publication No. SHO 58-210084 (1983) and pelerine compound described in the Laid-open Publication No. HEI 7-188178 (1995) will also do.

Of the above compounds, applicable fluorescent colors or pigments are carbocyanine pigment, xanthene pigment, triaryl methane pigment, acrizine pigment, coumarin and azacoumalin pigment, phthal-imide and naphthal-imide compound, pyrylium compound, diketopirolo pyrrole compound, pelerine compound; and zinc sulfide activated with copper, silver or manganese, zinc silicate activated with manganese, zinc sulfide cadmium activated with silver or copper, calcium sulfide activated with bismuth, strontium sulfide activated with samarium or cerium, calcium tungstate activated with lead, Sr(PO4)3Cl activated with europium, Zn2GeO2 activated with europium, Y2O2S activated with europium, and Y2O3 activated with europium. Applicable fluorescent color also includes fluorescein, coumarin, oxazole, pyrazoline, thiadiazole, spiro-pyrane, pyrene-sulfonate, benzo-imidazole, and diamino-stilbene types.

Heat melting type thermal transfer sheet is preferred to contain fluorescent agent by 0.5 to 80 weight % of total solid content. If it is less than 0.5 weight %, coloring property degrades. If it exceeds 80 weight %, there arises a problem that adhesion with adjacent layers degrades. These various fluorescent agents can be used independently or in combination with two or more.

<Pearl Pigment>

Pearl pigment means material containing scale powder. Scale powder (hereinafter called the pearl pigment) is made from mica coated with metallic oxide or metallic sulfide thin film, which is transparent in visible area and of which refraction is more than 2.0, so as to add the reflectivity (high-iris reflection) to the mica. It is a single-layer or double-layer coating of Sb2S3,-Fe2O3, PbO, ZnSe, CdS, Bi2O3, TiO2, PbCl2, CeO2, Ta2O5, ZnS, ZnO, CdO, Nd2O3, Sb2O3, SiO, or InO3 for example.

Since the refractive index of mica combined with metallic oxide film becomes greater than 0.4, more reflection of incident white light is caused and also double-refraction is caused on the interface between mica and metallic oxide film, resulting in high-iris reflection, which in turn effectively promotes discoloration effect.

In this composition, it is possible to cause high-iris reflection of desired tone by controlling the film thickness of the metallic oxide to be coated on mica, and the film thickness is desired to be 10 to 10000 angstroms, or preferably 200 to 5000 angstroms because this thickness causes high-iris reflection in the visible area. To be concrete, pigments described in the Japanese Application Patent Laid-open Publication Nos. HEI 6-145553 (1994), HEI 8-209024 (1996), HEI 8-269358 (1996), HEI 10-101957 (1998), HEI 11-273932 (1999), HEI 11-315219 (1999), 2000-1628, 2000-44834, and HEI 1-158077 (1989) are applicable. Scale pigment available in the market is, for example, “Iriodin” (product name, manufactured by MERCK).

“Iriodin” is a stable inorganic scale pigment made of natural mica coated with metallic oxide having high refractive index such as titanium oxide and iron oxide, wherein the light reflecting at the boundary between the titanium oxide having high refractive index and mica and adjacent medium having low refractive index causes pearly gloss. By varying the film thickness of the coated titanium oxide on this “Iriodin”, specific high-luster color can be intensified. Heat melting type thermal transfer sheet is preferred to contain the above scale pigment by 10 to 60 weight % of total solid content. If it is less than 10 weight %, coloring property degrades. If it exceeds 60 weight %, there arises a problem that adhesion with adjacent layers degrades. These various pearl pigments can be used independently or in combination with two or more.

<IR Absorber>

IR absorber means a layer containing material that absorbs infrared light. The material that absorbs infrared light can be any, including IR absorbing inorganic material, IR absorbing pigment, IR absorbing organic material, IR absorbing color and IR absorbing fluorescent agent, and there is not limitation.

IR absorbing inorganic material includes the above mentioned metals such as Nd, Yb, In, and Sn, oxide thereof, sulfide thereof, halide thereof, and compound thereof. Among all, conductive oxide, ITO exhibits particularly high IR absorption. To be concrete, compounds described in the Japanese Application Patent Laid-open Publication Nos. HEI 7-113072 (1995), HEI 7-310072 (1995), and HEI 8-113776 (1996) are applicable.

IR absorbing pigment includes cyanine pigment, squalium pigment, chroconium pigment, azulenium pigment, phthalo-cyanine pigment, naphthalo-cyanine pigment, polymethine pigment, naphtho quinone pigment, thio-pyrylium pigment, dithiol pigment, antra-quinone pigment, indo-aniline metallic complex pigment, and inter-molecular CT pigment. Compounds described in the Japanese Application Patent Laid-open Publication Nos. SHO 63-139191 (1988), SHO 64-33547 (1988), HEI 1-160683 (1989), HEI 1-280750 (1989), 1-293343 (1989), HEI 2-2074 (1990), HEI 3-26593 (1991), HEI 3-30991 (1991), HEI 3-34891 (1991), HEI 3-36093 (1991), HEI 3-36094 (1991), HEI 3-36095 (1991), HEI 3-42281 (1991), HEI 3-103476 (1991), and HEI 5-201140. (1993) are applicable as the above IR absorbing pigment.

In a heat melting type thermal transfer sheet, it may be preferable that an infrared absorption material is included 5 to 70% by weight to the total solid component. If it is 5 or less % by weight, it may be problem, because absorption becomes weak. If it is 70 or more % by weight, it may be problem, because Adhesion with a neighboring layer is deteriorated. These various infrared absorption agent may be used by one kind independently, and may use two or more kinds together if needed.

<Additive>

Additives other than those mentioned above can be added to the aforementioned hot melt ink layer, as required, without sacrificing the object of the present invention. For example, this hot melt ink layer may be impregnated with a fluorine based surface active agent. The presence of the fluorine based surface active agent prevents the hot melt ink layer-from being blocked. Further, addition of the organic and inorganic fine grains and non-compatible resins is effective in improving the sharpness of the image containing the text information, viz., delimitation of the character boundary.

<Thickness of a Hot Melt Ink Layer and a Forming Method of it>

The film thickness of the hot melt ink layer is normally 0.6 through 5.0 μm, and in particular preferably 1.0 through 4.0 μm. This hot melt ink layer can be coated according to the method (organic solvent method) where coating is performed with the forming components dispersed or dissolved in organic solvent, or according to the method (hot melt coating method) where coating is performed by putting thermoplastic resin in a softened or molten state through heating. Preferably, coating is performed using the emulsion obtained by dispersing or dissolving the forming component in water and organic solvent or the solvent.

The total content of the layer forming component in the coating solution used for coating the hot melt ink layer is normally set at 5 through 50 wt %. The conventional coating method can be utilized. The coating method includes the wire bar method, squeeze coating method and gravure coating method. The hot melt ink layer is preferably composed of at least one layer. For example, it can be formed by laminating two or more hot melt ink layers different from each other in the type and content of the coloring agent or in the mix proportion of thermoplastic resin and hot melt compound.

As the above-mentioned thermoplastic resin, ethylene based copolymers, such as ethylene-vinyl acetate based resin, PA based resin, polyester based resin, polyurethane based resin, polyolefin based resin, acrylics based resin, cellulose based resin, etc. can be employed, for example. In addition, for example, rosin derivatives, such as elastomers, such as vinyl chloride based resin, rosin based resin, petroleum based resin and resin, such as ionomer resin, a natural rubber, styrene-butadiene rubber, polyisoprene rubber, and polychloroprene rubber, rosin ester, a rosin maleic resin, a rosin phenol resin, and hydrogenation rosin, and a phenol resin, terpene resin, cyclopentadiene resin, aromatic series resin, etc. are available according to a case.

In this invention, as a thermoplastic resin used as a compositions of the above-mentioned stripping layer, among various thermoplastic resin of the above-mentioned exemplification, a resin having a melting point or a softening point of 50-150 degrees C., especially in the range of 60-120 degrees C., or a resin obtaining the above range by being mixed with two or more kinds of resins may be used suitably. The above-mentioned stripping layer may contain a colorant suitably by a case. When making the above-mentioned stripping layer contain a colorant, it may be appropriate that the content of the colorant is set to be usually 30% by weight to all the compositions that constitute the stripping layer, preferably to be 20 or less % by weight. of a rate preferably 30 or less % of the weight.

The thickness of the stripping layer usually may be a rang of 0.2 to 4 μm, preferably a range of 0.5 to 2.5 μm.

<Production of a Heat Melting Type Thermal Transfer Recording Ink Sheet>

Basically, the heat melting type thermal transfer recording ink sheet may be formed by coating on a support a heat meltable ink layer forming coating liquid in which components to form a heat meltable ink layer are dispersed or dissolved and by drying it.

<Heat Melting Type Thermal Transfer Recoding Method>

The hot melt transfer method (heat melting type thermal transfer recording method) using the aforementioned hot melt transfer recording ink sheet is not different from the conventional thermal transfer recording method. The following describes the case where a thermal head most typically used as a heat source is employed. In the first place, the hot melt ink layer of the hot melt transfer recording ink sheet and the image receiving layer of the substrate are brought into close contact. If required, thermal pulses are given to the hot melt ink layer by the thermal head, thereby locally heating the hot melt ink layer corresponding to the desired printing or the transfer pattern.

With the rise of temperature, the heated portion of the hot melt ink layer is quickly softened and is transferred to the image receiving surface of the substrate. The non-gradation information containing image that does not require gradation of the text, graphics symbol or ruled line may be formed, prior to formation of the aforementioned gradation information containing image. Alternatively it may be formed after formation of the gradation information containing image. The text information containing image can also be formed by using the sublimation transfer recording ink sheet.

In the present invention, the image receiving layer of the thermal transfer recording image receiving sheet and hot melt transfer recording sheet are placed one on top of the other. When a text information containing image is formed, a gradation information containing image is preferably formed under a pressure of 0.3 through 0.01 kg/cm² applied in response to the recording signal at a head temperature of 50 through 500 degrees Celsius, preferably 100 through 500 degrees Celsius, more preferably 100 through 400 degrees Celsius. A more preferable pressure is 0.25 through 0.01 kg/cm², and a still more preferable pressure is 0.25 through 0.02 kg/mm².

<C. Retransfer Recording Method>

As stated above, an image may be printed directly with a sublimation type recording method and a heat melt type recording method. However, as another embodiment to record an image, it may be preferably to use a retransfer method employing an image receiving sheet.

More concretely, after conducting printing by the use of a sublimation type recording ink ribbon or a heat melt type recording ink ribbon with a sublimation type thermal transfer recording method or a heat melt type thermal transfer recording method, it may be preferable to an authentication recording medium paper substrate adhesive layer. Further, it may be preferable to provide a substrate light scattering prevention layer previously on a paper substrate having center line average roughness (Ra) of 0.5 to 8.0 μm or a paper substrate subjected to a format printing and having center line average roughness (Ra) of 0.5,to 8.0 μm, in other words, there is not special limitation.

In the invention, by providing a substrate light scattering prevention layer (an authentication recording medium paper substrate adhesive layer) previously on a paper substrate having center line average roughness (Ra) of 0.5 to 8.0 μm, the sharpness and the image quality of a face image recording layer or personal information recording layer can be improved. Further, when a hologram is laminated, a good authentication recording medium can be obtained without lowering the appearance of the hologram.

<Image-Receiving Sheet>

It is desirable that an image-receiving sheet of this invention functions as transfer foil. Incidentally, in the invention, an image-receiving sheet can be used at least one time or more. It is desirable that the image-receiving sheet may includes one or more layers of an image receiving layer for a sublimation type thermal transfer and a photo-curing layer. More preferably, in addition to an image receiving layer for a sublimation type thermal transfer and a photo-curing layer, a stripping layer is provided as a stripping force adjusting layer for a substrate of an image receiving sheet. In addition to an image receiving layer for a sublimation type thermal transfer, a photo-curing layer, and a stripping layer, in order to enhance a adhesion force between layers and lamination capability, It is desirable to an intermediate layer and a barrier layer. Also, it may be possible to provide at lest one of an optical change element layer and a hologram layer in order to add a falsification and modification preventing function. Since an image receiving sheet used in the second process is located at the outermost layer of an authentication recording medium, it may be preferable to provide a photo-curing type resin layer.

<Support>

The support member is a simple layer or a laminated layer composed of two more of these layers, comprising the synthetic resin sheet, paper such as bond paper, tissue paper, glassine paper and parchment paper, and metal foils, wherein the synthetic resin sheet comprising:

a polyester resin such as polyethylene terephthalate, polybutylene terephthalate and polyethylene terephthalate/isophthalate copolymer;

a polyolefin resin such as polyethylene, polypropylene and polymethyl pentene;

a polyethylene fluoride resin such as polyvinyl fluoride, polyvinylidene fluoride, polyethylene tetrafluoride and ethylene-tetrafluoride copolymer;

a polyamide such as such as nylon 6 and nylon 6.6, a vinyl polymer such as polyvinyl chloride, vinyl chloride/vinyl acetate copolymer, ethylene/vinyl acetate copolymer, ethylene/vinyl alcohol copolymer, polyvinyl alcohol and vinylon;

a cellulose resin such as cellulose triacetate and cellophane;

a acryl resin such as polymethyl methacrylate, polyethyl methacrylate, polyethyl acrylate and polybutyl acrylate; and

a synthetic resin such as polystyrene, polycarbonate, polyarylate and polyimide.

The thickness of the support member in the present invention is 10 through 200 μm, preferably 15 through 80 μm. If the thickness is 10 μm or less, the support member may be damaging during the process of transfer. In the specific stripping layer, use of polyethylene terephthalate is preferred.

The support member in the present invention can be provided with a concavo-convex pattern, if required. The concavo-convex pattern can be formed by rubbing of a matting agent, sand blasting, hairline processing, matte coating or chemical etching. In the case of matte coating, either an organic or inorganic substance can be used. For example, the inorganic substance includes silica disclosed in the Swiss Patent No. 330,158; glass powder disclosed in the French Patent No. 1,296,995; alkaline earth metal, cadmium; and carbonate such as zinc. Disclosed in the English Patent No. 1,173,181, they can be used as matting agents. The organic matting agents that can be used are:

organic substance includes: starch disclosed in the U.S. Pat. No. 2,322,037; starch derivatives disclosed in the Belgium Patent No. 625,451 and English Patent No. 981,198; polyvinyl alcohol described in Japanese Patent Tokkosho 44-3643; polystyrene or polymethacrylate disclosed in the Swiss Patent 330,158; polyacrylonitrile described in U.S. Pat. No. 3,079,257; and polycarbonate described in U.S. Pat. No. 3,022,169. The matting agent is coated by dispersing the matting agent in a coating solution in advance. The matting agent can be coated by spraying it after the coating solution has been applied, before it is dried up. When a plurality of matting agents are added, both of the aforementioned methods can be used in combination. When concavo-convex patterns are provided, they can be provided on either the transfer surface or the reverse surface. To provide a static eliminating means subsequent to transfer and stripping, a static eliminating layer can be formed. It can be formed on both or either side of the support member.

<Stripping Layer>

The stripping layer can be made of a resin, such as acryl resin, polyvinyl acetal resin and polyvinyl butyral resin, having a high glass transition temperature. It can also comprise waxes, silicone oils, fluorine compound, water-soluble polyvinyl pyrrolidone resin, polyvinyl alcohol resin, Si modified polyvinyl alcohol resin, methyl cellulose resin, hydroxy cellulose resin, silicone resin, paraffin wax, acryl modified silicone, polyethylene wax, ethylene vinyl acetate, and other resins of similar kind. Further, this layer can be composed of polydimethyl siloxane, its modified substances, e.g. polyester modified silicone, acryl modified silicone, urethane modified silicone, alkyd modified silicone, amino modified silicone, epoxy modified silicone, polyether modified silicone, such other oils and resins, and their cured substances. Other fluorine compounds include fluorinated olefin and perfluoro phosphoric acid ester compounds. The preferred compounds of olefin derivatives are dispersions of polyethylene and polypropylene, and long-chain alkyl derivative compounds such as polyethyleneimine octadesyl. These mold releasing agents having a poor solubility can be used through a process of dispersion.

When two transfer foils are-to be transferred, thermoplastic elastomer can be added. The thermoplastic resin elastomer specifically includes styrene derivatives (styrene block copolymer (SBC)), olefin derivatives (TP), urethane (TPU), polyester (TPEE), polyamide derivatives (TPAE), 1,2-polybutadiene derivatives, polyvinyl chloride derivatives (TPVC), fluorine derivatives, ionomer resin, chlorinated polyethylene, and silicone derivatives. More specific examples are described in “12996 Chemical Products” for 1996 (Kagaku Kogyo Nippo Co., Ltd.). The thickness of the stripping layer is preferably 0.000001 through 5.0 μm, more preferably 0.000001 through 3.0 μm, still more preferably 0.00005 through 3.0 μm. If required, a thermoplastic resin layer may be arranged between the stripping layer and resin layer or activated light curing layer in the present invention. To put it more specifically, it is possible to use polyester resin, acryl resin, epoxy resin, xylene resin, guanamine resin, diallyl phthalate resin, phenol resin, polyimide resin, maleic acid resin, melamine resin, urea resin, polyamide resin, urethane resin and others.

<Image Receiving Layer for a Sublimation Type Thermal Transferring>

The image receiving layer can be formed with a binder and additives.

In the image receiving layer of the invention, since a gradation information containing image is formed by a sublimation type thermal transfer method, in addition, a character information containing image can be formed by a sublimation type thermal transfer method or a melt type thermal transfer method, the dyeing affinity of a sublimatble dye or a adhesion property of a heat meltable ink as well as the dyeing affinity of a sublimatble dye is required to be good. In order to provide such a specific characteristic to an image receiving layer, ad described later, it is necessary to adjust properly and a kind and an added amount of a binder and the additives.

The following describes components forming an image receiving layer.

The commonly known binder of the image receiving layer for sublimation heat transfer and recording can be used appropriately as the binder of the image receiving layer of the present invention. For example, polyvinyl chloride, copolymer resin between polyvinyl chloride and other monomers (e.g. isobutyl ether and vinyl propionate), polyester resin, poly(metha)acrylic ester, polyvinyl pyrrolidone, polyvinyl acetal resin, polyvinyl butyral resin, polyvinyl alcohol, polycarbonate, cellulose triacetate, polystyrene, copolymer between styrene and other monomers (e.g. acrylate, acrylic ester, acrylonitrile and ethylene chloride), vinyl toluene acrylate resin, polyurethane, polyamide resin, urea resin, epoxy resin, phenoxy resin, polycaprolactone resin, polyacrylonitrile resin, and their modified substances. It is preferred to use polyvinyl chloride resin, copolymer resin between polyvinyl chloride and other monomers, polyester resin, polyvinyl acetal resin, polyvinyl butyral resin, copolymer between styrene and other monomers, epoxy resin, photocurable resin, thermosetting plastic resin and various types of binders.

When forming an image receiving layer in the present invention, inclusion of metal ion-containing compound is preferred. In particular, the heat migratory compound reacts with this metal ion-containing compound to form a chelate.

A divalent and polyvalent metal in the Group I or VIII of the periodic table can be mentioned as a metal ion constituting the aforementioned metal ion-containing compound. Preferred elements include Al, Co, Cr, Cu, Fe, Mg, Mn, Mo, Ni, Sn, Ti and Zn. Particularly preferred elements include Ni, Cu, Co, Cr and Zn. The preferable compounds containing these metal ions include the inorganic or organic salt of the metal, and complex of the metal. To put it more specifically, the complex, containing Ni2⁺, Cu2⁺, Co2⁺, Cr2⁺ and Zn2⁺, expressed by the following general formula is preferably utilized:
[M(Q1)k(Q²)m(Q3)n]p+p(L⁻)

where M in the formula denotes metal ion, and Q1, Q2 and Q3 indicate coordinate compounds, expressed by “M”, which can coordinate with the metal ion. For example, they can be selected from the coordinate compounds given in “Chelate Chemical (5)” (Nankodo Co., Ltd.). A particularly preferred compound is the coordinate compound, containing at least one amino group, which coordinates with metal. To put it more specifically, such a compound includes ethylene diamine, and its derivatives, glycine amide and its derivatives, and picolinic amide and its derivatives.

“L” denotes a counter anion that can form a complex, and includes an inorganic compound anion such as Cr, SO4 and ClO4, and an organic compound such as benzene sulfonic acid derivative and alkyl sulfonic acid derivative. Particularly preferred ones include tetraphenyl boron anion and its derivative, and alkyl benzene sulfonic acid and its derivative. “k” denotes the integer of 1, 2 or 3, and “m” shows 1, 2 or 0. “n” represents 1 or 0. They depends on whether the complex expressed in the aforementioned general formula is a quadridentate or sexadentate ligand, or are determined by the number of the ligands, of the Q1, Q2 and Q3.

The metal ion-containing compound of this type includes the one disclosed in the U.S. Pat. No. 4,987,049. When the aforementioned metal ion-containing compound is added, its amount is preferably 0.5 through 20 g/m², or more preferably 1 through 15 g/m² with respect to the image receiving layer.

Use of a mold releasing agent is preferred for the image receiving layer. The effective mold releasing agent is preferred to have compatibility with the binder used. To put it more specifically, such an agent typically includes modified silicone oil and modified silicone polymer. For example, it can be exemplified by amino modified silicone oil, epoxy modified silicone oil, polyester modified silicone oil, acryl modified silicone oil, urethane modified silicone oil, wax and the like.

The image receiving layer of the present invention can be manufactured as follows: A coating solution for the image receiving layer is prepared, and the coating solution for the image receiving layer is applied on the surface of the aforementioned support member. Then it is dried to get the image receiving layer.

The thickness of the image receiving layer formed on the surface of the support member is generally 1 through 50 μm, preferably about 2 through 10 μm.

In this invention, an information bearing body layer which is structured by a format printing can be prepared on an image receiving layer.

If a layer thickness is 1 μm or less, it may be problem that the function of the image receiving layer may be lowered and the resistance for scratch after transferring may be lowered. Moreover, if a layer thickness is thicker, it may be problem that the function of the image receiving layer may be lowered and the transferring ability becomes poor.

(Photocurable Resin)

To put it more specifically, photocurable image recording medium protective layer material is provided with addition polymerization and ring opening polymerization properties.

The addition polymerizable compound can be a radical polymerized compound or a photopolymerized composition (including thermopolymerized composition) disclosed in the Japanese Patent Tokkaihei 7-159983 and Tokkohei 7-31399. A cationic polymerized photocurable material is known as the addition polymerized compound. In recent years, the photocationic polymerized photocurable material sensitized to the long wavelength region in excess of the visible light is disclosed in the Japanese Patent Tokkaihei 6-43633. A composition as a hybrid polymerized photocurable material is disclosed in the Japanese Patent Tokkaihei 4-181944. To put it more specifically, if there is a photocurable resin layer containing any one of the aforementioned cationic initiators cationic polymerized compound, radical initiator and radical polymerized compound, any photocurable resin layer can be adopted for the purpose of the present invention.

<Radical Polymerized Initiator>

The radical polymerized initiator is exemplified by:

a triazine derivative disclosed in the Japanese Patent Tokkosho 59-1281, Japanese Patent Tokkosho 61-9621, and Japanese Patent Tokkaisho 60-60104;

an organic peroxide disclosed in the Japanese Patent Tokkaisho 59-1504 and Japanese Patent Tokkaisho 61-243807;

a diazonium compound disclosed in the Japanese Patent Tokkosho 43-23684, the Japanese Patent Tokkosho 44-6413, the Japanese Patent Tokkosho 47-1604, and U.S. Pat. No. 3,567,453;

an organic azido compound disclosed in the U.S. Pat. No. 2,848,328, U.S. Pat. No. 2,852,379 and U.S. Pat. No. 2,940,853;

ortho-quinone diazido disclosed in the Japanese Patent Tokkosho 36-22062, Japanese Patent Tokkosho 37-13109, Japanese Patent Tokkosho 38-18015 and Japanese Patent Tokkosho 45-9610;

various types of onium compounds disclosed in the Japanese Patent Tokkosho 55-39162, Japanese Patent Tokkaisho 59-14023 and “Macromolecules”, Vol. 10, P. 1307 (1977);

an azo compound disclosed in the Japanese Patent Tokkaisho 59-142205;

a metal allene complex disclosed in the Japanese Patent Tokkaihei 1-54440, European Patent No. 109,851, European Patent No. 126,712,.and “Journal of Imaging Science” (J. Imag. Sci.), Vol. 30, P. 174 (1986);

an (oxo)sulfonium organic boron complex disclosed in the Japanese Patent Tokkaihei 5-213861 and Japanese Patent Tokkaihei 5-255347;

titanocene disclosed in the Japanese Patent Tokkaisho 61-151197;

transition metal complex disclosed in “Coordination Chemistry Review”, Vol. 84, pp. 85-277) (1988) and Japanese Patent Tokkaihei 2-182701;

2,4,5-triaryl imidazole dimer and carbon tetrabromide disclosed in the Japanese Patent Tokkaihei 3-209477; and

a organic halogen compound disclosed in the Japanese Patent Tokkaisho 59-107344.

0.01 through 10 parts by weight of these polymerized initiators are preferably contained with respect to 100 parts by weight of a compound containing an unsaturated linkage of radical polymerizable ethylene.

The photosensitive composition containing radical polymerized compound may contain the radical polymerized initiator commonly used in high molecular synthesis reaction by radical polymerization, as a thermally polymerized initiator of radical polymerized monomer. The thermally polymerized initiator in the sense in which it is used here refers to a compound capable of generating a polymerized radical when supplied with thermal energy.

Such a compound includes:

azobinitrile compound such as 2,2′-azobisisobutyronitrile and 2,2′-azobispropionitrile;

organic peroxide ion such as benzoyl peroxide, lauroyl peroxide, acetyl peroxide, perbenzoic acid t-butyl, α-cumylhydroperoxide, di-t-butylperoxide, diisopropylperoxy dicarbonate, t-butylperoxy isopropyl carbonate, peroxy acids, alkylperoxy carbamate, nitrosoarylacylamine;

inorganic peroxide such as potassium persulfide, ammonium persulfide and potassium perchlorate;

an azo or diazo compound such as diazo aminobenzene, p-nitrobenzene diazonium, azobis substitution alkane, diazo thioether and aryl azosulfon.

It further includes nitrosophenyl urea, tetramethylthiuram disulfide, diaryl disulfide, dibenzoil disulfide, tetraalkylthiuram disulfide, dialkyldisulfide xanthogenate, aryl sulfinic acid, aryl alkyl sulfone and 1-alkane sulfinic acid.

The compounds particularly preferable among these compounds have excellent stability at a normal temperature and a high decomposition speed during heating, and become colorless when decomposed. Such compounds include benzoyl peroxide and 2,2′-azobisisobutyronitrile. In the present invention, one thermally polymerized initiator or a combination of two or more of these thermally polymerized initiators can be used. Further, the preferable amount of the thermally polymerized initiator in a thermally polymerized composition is 0.1 through 30 wt %, and the more preferable amount is 0.5 through 20 wt %.

[Radical Polymerized Photocurable Resin]

The radical polymerized compound contained in the radical polymerized photocurable resin contains a normal photo-polymerized compound and thermal polymerized compound. The radical polymerized compound is a compound containing an unsaturated linkage of radical polymerizable ethylene. Any compound can be used if it contains at least one unsaturated linkage of radical polymerizable ethylene in the molecule. The monomer, oligomer, polymer and others having such a chemical form are included therein. Only one radical polymerized compound can be used, or two or more radical polymerized compounds in a desired proportion can be used to improve the intended object.

The compound having an unsaturated linkage of radical polymerizable ethylene can be exemplified by acrylic acid, methacrylic acid, itaconic acid, crotonic acid, isocrotonic acid, maleic acid, other unsaturated carboxylic acids similar to them, their salts, ester, urethane, amide, anhydride, acrylonitrile, styrene, various unsaturated polyester, unsaturated polyester, unsaturated polyamide, unsaturated urethane, and such other radical polymerized compounds. To put it more specifically, it includes:.

acryl derivatives such as 2-ethylhexylacrylate, 2-hydroxyethylacrylate, butoxyethylacrylate, carbitol acrylate, cyclohexylacrylate, tetrahydro furfurylaacrylate, benzylacrylate, bis(4-acryloxy polyethoxy phenyl)propane, neopentyl glycol diacrylate, 1,6-hexandiol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerithritol triacrylate, pentaerithritol tetraacrylate, dipentaerithritol tetraacrylate, trimethyrol propane triacrylate, tetramethyrol methane tetraacrylate, oligoester acrylate, N-methyrol acrylamide, diacetone acrylamide, and epoxy acrylate;

methacryl derivatives such as methyl methacrylate, n-butyl methacrylate, 2-ethylhexyl methacrylate, lauryl methacrylate, allyl methacrylate, glycidyl methacrylate, benzyl methacrylate, dimethyl aminomethyl methacrylate, 1,6-hexane diol dimethacrylate, ethylene glycol dimethacrylate, triethylene glycol dimethacrylate, polyethylene glycol dimethacrylate, polypropylene glycol dimethacrylate, trimethyrol ethane trimethacrylate, trimethyrol propane trimethacrylate, and 2,2-bis(4-methacryloxy polyethoxyphenyl)propane; and

derivatives of allyl compound such as allyl glycidyl ether, diallyl phthalate and triallyl trimellitate.

To put it more specifically, it includes the commercially available products listed in “Crosslinking Agent Handbook” edited by YAMASHITA Shinzo (1981, Taiseisha Co., Ltd.); “UV.EB Curing Handbook (Part: Material)” edited by KATO Kiyomi (1985, High Polymer Publishing Association); “Application of UV.EB Curing Technology and its Market” edited by Ladtec Research Association, P. 79 (1989, C.M.C); and TAKIYAMA Eichiro: “Polyester Resin Handbook”, (1988, Nikkan Kogyo Shimbun Ltd.). It also includes the radical polymerized compound, crosslinking monomer, oligomer and polymer. The amount of the aforementioned radical polymerized compounds to be added in the radical polymerized composition is preferably 1 through 97 wt %, more preferably 30 through 95 wt %.

[Acid Cross-Linked Photocurable Resin]

The crosslinking agent used in the acid cross-linked composition of the present invention is a compound that is subjected to crosslinking reaction due to the acid generated from a specific compound of the present invention when exposed to activated light or radiation. The crosslinking agent preferably used in the present invention is a compound that contains two or more hydroxy methyl groups, alkoxy methyl groups, epoxy groups or vinyl ether groups inside the molecule. It is preferably a compound where these crosslinked functional groups are directly with the aromatic ring. To put it more specifically, it includes methyrol melamine, resol resin, epoxidated novolak resin and urea resin. Further, preferable compounds are described in the “Crosslinking Agent Handbook” (YAMASHITA Shinzo and KANEKO Tohsuke, Taiseisha Co., Ltd.). Particularly, the phenol derivative containing two or more hydroxymethyl groups or alkoxy methyl groups inside the molecule is preferably characterized by excellent strength of the image section when an image has been formed. A specific substance of such a phenol derivative is a resol resin.

However, these crosslinking agents are instable to heat. They have poor storage stability after the image recording medium has been produced. By contrast, excellent storage stability is provided by the phenol derivative, containing two or more hydroxymethyl groups connected with the benzene ring inside the molecule, having a molecular weight of 1,200 or less. It is most preferably used in the present invention. The alkoxy methyl group is preferred to have a carbon number of 6. To put it more specifically, the preferred groups are a methoxy methyl group, ethoxy methyl group, n-propoxy methyl group, isopropoxy methyl group, n-butoxy methyl group, isobutoxy methyl group, sec-butoxy methyl group and t-butoxy methyl group. Further, the alkoxy-substituted alkoxy methyl group such as a 2-methoxy ethoxy methyl group and 2-methoxy-1-propoxy methyl group is most preferable. To put it more specifically, preferable compounds are those listed in the Japanese Patent Tokkaihei 6-282067, Japanese Patent Tokkaihei 7-64285, EP632 and 003A1.

Other crosslinking agents preferably used in the present invention are aldehyde and ketone compounds. The compound having two or more aldehyde or ketone groups in the molecule are preferred.

In the present invention, the amount of the crosslinking agent to be added in the overall image recording medium solid is 5 through 70 wt % preferably 10 through 65 wt %. If the amount of the crosslinking agent to be added is less than 5 wt %, the film strength of the image section will be reduced when an image has been recorded. If it is over 70 wt %, the storage stability will be adversely affected. These crosslinking agents can be used independently or two or more agents can be used in combination.

<Cationic Polymerized Initiator>

The cationic polymerized initiator is preferred as an initiator. To put it more specifically, it includes an aromatic onium salt. The aromatic onium salt is:

the salt of Group Va element in the Periodic Table, e.g. phosphonium salt (e.g. triphenylphenacyl phosphonium hexafluoro phosphate);

the salt of Group VIa element in the Periodic Table, e.g. sulfonium salt (e.g. triphenyl sulfonium tetrafluoro borate, triphenyl sulfonium hexafluoro phosphate, tris(4-thiomethoxy phenyl)hexafluoro phosphate, sulfonium and triphenyl sulfonium hexafluoro antimonate); and

the salt of the Group VIIa element; e.g. iodoniumu salt (e.g. diphenyl iodonium chloride).

Use of such an aromatic onium salt as a cationic polymerized initiator in the polymerization of the epoxy compound is disclosed-in the U.S. Patent No. 4,058,401, U.S. Pat. No. 4,069,055, U.S. Pat. No. 4,101,513 and U.S. Pat. No. 4,161,478.

A preferable cationic polymerized initiator is exemplified by the sulfonium salts in the Group VIa element. From the viewpoint of the ultraviolet curability and the storage stability of the ultraviolet curable composition, triallyl sulfonium hexafluoro antimonate is preferable. Further, it is possible to use the photo-polymerization initiators given on pages 39 through 56 of the Photopolymer Handbook (edited by Photopolymer Forum, Industrial Research Committee, 1989), and the compounds disclosed in the Japanese Patent Tokkaisho 64-13142 and Japanese Patent Tokkaihei 2-4804.

<Cationic Polymerized Photocurable Resin>

As a cationic polymerized compound, the ultraviolet curable prepolymer or monomer of the type (mainly epoxy) that is turned into a high molecular compound by cationic polymerization includes a prepolymer containing two or more epoxy groups in each molecule. Such a prepolymer includes aliphatic ring type polyepoxides, polyglycidyl esher of. polybasic acid, polyglycidyl ether of polyvalent alcohol, polyglycidyl ether of polyoxyalkylene glycol, polyglycidyl ether of aromatic polyol, hydrogenated compounds of polyglycidyl ether of aromatic polyol, urethane polyepoxy compounds, and epoxidized polybutadiene. These prepolymers can be used independently or two or more of them can be used in combination.

The preferable amount of the prepolymer containing two or more epoxy groups in one molecule is 70 wt % or more. In addition to the examples given above, the cationic polymerized compound contained in the cationic polymerized composition includes (1) styrene derivatives, (2) vinyl naphthalene derivatives, (3) vinyl ether and its related substances and (4) N-vinyl compounds, which are listed below:

(1) Styrene Derivative

Styrene, p-methyl styrene, p-methoxy styrene, β-methyl styrene, p-methyl-β-methyl styrene, α-methyl styrene and p-methoxy-β-methyl styrene, etc.

(2) Vinyl Naphthalene Derivatives

1-vinyl naphthalene, α-methyl-1-vinyl naphthalene, β-methyl-1-vinyl naphthalene, 4-methyl-1-vinyl naphthalene, 4-methoxy-1-vinyl naphthalene, etc.

(3) Vinyl Ether and its Related Substances

Isobutyl vinyl ether, ethyl vinyl ether, phenyl vinyl ether, p-methyl phenyl vinyl ether, p-methoxy phenyl vinyl ether, α-methyl phenyl vinyl ether, β-methyl isobutyl vinyl ether, β-chloroisobutyl vinyl ether, etc.

(4) N-vinyl Compounds

N-vinyl carbazole, N-vinyl pyrrolidone, N-vinyl indole, N-vinyl pyrrole, N-vinyl phenothiazine, N-vinyl acetoanilide, N-vinyl ethylacetoamide, N-vinyl succinimide, N-vinyl phthalimide, N-vinyl caprolactam, N-vinyl imidazole, etc. The amount of the aforementioned cationic polymerized compound in the cationic polymerized compositions is 1 through 97 wt %, preferably 30 through 95 wt %.

<Hybrid Photocurable Resin Layer>

For the hybrid type (a combined use of radical polymerized type and cationic polymerized type), its compositions are listed in the Japanese Patent Tokkaihei 4-181944 and others. To put it more specifically, any one of the aforementioned cationic polymerized initiator, cationic polymerized compound, radical initiator and radical polymerized compound should be contained. In the present invention, the cationic polymerized compound is preferred to contain the vinyl ether base compound.

<Ultraviolet Absorber>

In the present invention, an ultraviolet absorber may be used in the photocurable resin containing layer. There is no restriction to the material used for the ultraviolet absorber layer if it performs the functions of the ultraviolet absorber for a pigment image and if it can be thermally transferred. For example, it is possible to use the compounds listed in the Japanese Patent Tokkaisho 59-158287, Japanese Patent Tokkaisho 63-74686, Japanese Patent Tokkaisho 63-145089, Japanese Patent Tokkaisho 59-196292, Japanese Patent Tokkaisho 62-229594, Japanese Patent Tokkaisho 63-122596, Japanese Patent Tokkaisho 61-283595, and Japanese Patent Tokkaihei 1-204788, as well as the compounds that can improve the image durability of the photos and other image recording media. To put it more specifically, salicylic acid derivatives, benzophenone derivatives, benzotriazole derivatives and cyanoacrylate derivatives can be mentioned. For example, it is possible to use the products having the following trademarks: Tinuvin P, Tinuvin 123, 234, 320, 326, 327, 328, 312, 315, 384, 400 (by Chiba Geigie Inc.), Sumisorb-110, 130, 140, 200, 250, 300, 320, 340, 350, 400 (by Sumitomo Chemical Co., Ltd.), MarkLa 32, 36, 1413 (by Adekaahgas Kagaku Inc.). Further, a pendant polymer having a benzophenone derivative on the side chain can also be used preferably. The inorganic fine grains having absorbing capacity on the ultraviolet area and ultrafine grain metallic oxide powder dispersant can also be employed. Titanium oxide, zinc oxide and silicon compound can be mentioned as the inorganic fine grain. The ultrafine grain metallic oxide powder dispersant can be manufactured includes the ultrafine grain zinc oxide powder and ultrafine grain titanium oxide powder manufactured by using water, alcohol or various types of oil-based dispersant, and surface active agent, water soluble polymer, solvent soluble polymer and such other dispersants.

The following other additives can also be added:
(1) pigments, sensitizer and photosensitizer described in “Pigment Handbook” edited by OKAWARA Nobuo et al. (1986, Kodansha Co., Ltd.), “Chemistry of Functional Pigment” edited by OKAWARA Nobuo et al. (1981, CMC), “Special Functional Material” edited by IKEMORI Chuzaburo et al. (1986, CMC) and Japanese Patent Tokuganhei 7-108045;
(2) polymerization accelerators chain transfer agents and polymerization inhibitors such as:

thiol and related substances disclosed in the U.S. Pat. No. 4,414,312 and Japanese Patent Tokkaisho 64-13144;

disulfides given in the Japanese Patent Tokkaihei 2-291561;

thion and related substances disclosed in the U.S. Pat. No. 3,558,322 and Japanese Patent Tokkaisho 64-17048; and

o-acyl thiohydroxyamate and N-alkoxy pyridinethion given in the Japanese Patent Tokkaihei 2-291560;
(3) static eliminating agents described in “11290 Chemical Products”, Kagakukogyo Nippo Co., Ltd., pp. 875-876;
(4) nonionic surface active agents described in the Japanese Patent Tokkaisho 62-251740 and Japanese Patent Tokkaihei 3-208514; and
(5) ampholytic surface active agents given in the Japanese Patent Tokkaisho 59-121044 and Japanese Patent Tokkaihei 4-13149.

Further, vinyl monomers such as polyvinyl butyral resin, polyurethane resin, polyamide resin, polyester resin, epoxy resin, novolak resin, styrene, paramethyl styrene, methacrylic acid ester and acrylic acid ester; and any other high molecular polymers such as cellulose monomers, thermoplastic polyester and naturally-occurring resin can be used in combination. Further, the following can also be used in combination: organic high molecular polymers given in “Practical Technology of New Photosensitive Resin” edited by AKAMATSU Kiyotaka (CMC, 1987), and “10188 Chemical Products” pp. 657-767 (Kakaku Kogyo Nippo, 1988).

In the present invention, particularly, the unsaturated group containing resin is preferably used. It includes the radical or polymerizable group. The unsaturated group in the sense in which it is used here refers to the glycidyl group, (metha)acryloyl group, vinyl group and others. To put it more specifically, it includes the resins having the following structure. The amount of these high molecular polymers used in the photosensitive composition is preferably 1 through 70 wt %, more preferably 5 through 50 wt %.

When the ultraviolet absorber and photocurable resin material are contained in the protective layer, the amount of the ultraviolet absorber is preferably 0 through 20 wt % relative to 100 wt % of the overall solid, more preferably 0 through 10 wt % or less. The thickness of the protective layer containing the ultraviolet absorber and photocurable resin material in the present invention is preferably 3 through 50 g/m, more preferably 3 through 40 g/m², still more preferably 3 through 35 g/m².

According to various objectives of the protective layer of the present invention, the following substances can be used in combination; dyes, organic and inorganic pigments, oxygen removing agent such as phosphine and phosphinate, reducing agent, anti-fogging agent, anti-discoloring agent, anti-halation agent, fluorescent whitening agent, coloring agent, extender, plasticizer, flame retardant, oxidant inhibitor, light stabilizer, foaming agent, mildew proofing agent, additives for assigning magnetism and other properties, dilution solvent, etc.

<Production Method>

When the photocurable layer of the present invention is formed on the image receiving sheet, conventional coating methods, such as rotary coating, wire bar coating, dip coating, felt coating, air knife coating, spray coating, air spray coating, electrostatic air spray coating, roll coating, blade coating and curtain coating methods may be conducted to form a coating layer, thereafter, the coating layer is exposed with the following active curing light so as to obtain a hardened layer with the light.

<Activated Light for Curing>

Means for curing after coating includes a laser, light emitting diode, xenon flash lamp, halogen lamp, carbon arc lamp, metal halide lamp, tungsten lamp, mercury lamp and non-electrode light source. It is preferred to use the xenon flash lamp, halogen lamp, carbon arc lamp, metal halide lamp, tungsten lamp, mercury lamp and non-electrode light source. The energy applied in this case can be adequately selected by adjusting the exposure distance, time and intensity, in conformity to the type of the polymerization initiator.

Further, when activated light is used for photocuring, a means can be used to ensure photocuring stability in a nitrogen flow under reduced pressure.

<Other Layers>

Although an adhesive layer is provided in this invention in order to improve peel force for a transfer substrate, a barrier layer, an intermediate layer, an optical change element layer, a hologram layer, etc. may be provided in addition to an image receiving layer for a sublimition type heat transfer description, a photo-curing layer, and a release layer mentioned above from a viewpoint of adhesion, an interlaminar bonding capability, and coating characteristics with a photo-curing layer, in other words, there is no special limitation.

It is desirable in this invention that there are any one or more of a barrier layer and an intermediate layer from a viewpoint of a printing capability to an image-receiving sheet and an adhesion ability of an image-receiving sheet and a print layer. In case that each layer is laminated, a barrier layer represents a layer which makes coating characteristics etc. improve. In case that each layer is laminated, an intermediate layer represents a layer which makes coating characteristics etc. improve and improve adhesion between layers. A hologram layer and an optical change element layer are layers which can be prepared when a falsification and modification prevention is needed, and when required, they can be prepared.

<Barrier Layer and Intermediate Layer>

As a material used for a barrier layer and an intermediate layer, for example, it is possible to use vinyl chloride resin, polyester resin, acryl resin, polyvinyl acetal resin, polyvinyl butyral resin, polyvinyl alcohol, polycarbonate, cellulose resin, styrene resin, urethane resin, amide resin, urea resin, epoxy resin, phenoxy resin, polycaprolactone resin, polyacrylonitrile resin, SEBS resin, SEPS resin and their modified substances.

Of the aforementioned resins, those preferable for the purpose of the present invention are vinyl chloride resin, polyester resin, acryl resin, polyvinyl butyral resin, styrene resin, epoxy resin, urethane resin, urethane acrylate resin, SEBS resin and SEPS resin. These resins can be used independently or in combination with others.

To put it more specifically, use of the thermoplastic resin composed of a block polymer of polystyrene and polyolefin and polyvinyl butyral is preferred. For the intermediate layer of the present invention, the polyvinyl butyral having a degree of polymerization of 1000 or more includes Esrec BH-3, BX-1, BX-2, BX-5, BX-55 and BH-S by Sekisui Chemical Co., Ltd. and Denka butyral #4000-2, #5000-A and #6000-EP by Denki Kagaku Kogyo Co., Ltd. are sold on the market. The resin having a low degree of polymerization before thermosetting can be used as a thermoplastic resin of the intermediate layer. The isocyanate curing agent and epoxy curing agent are used for thermosetting. Thermosetting is preferably carried out at 50 through 90 degrees Celsius for 1 through 24 hours. Further, this intermediate layer may contain such additives as the aforementioned ultraviolet absorber, oxidant inhibitor, light stabilizer and static eliminating agent. When the ultraviolet absorber is added, its amount is preferably 0 through 20 wt % relative to 100 wt % of the overall solid, more preferably 0 through 10 wt %. The thickness of the intermediate layer is preferably 0.1 through 3.0 μm, more preferably 0.1 through 2.5 μm. Further, additives such as the aforementioned ultraviolet absorber, oxidant inhibitor, and-light stabilizer my be contained. When an ultraviolet absorber, oxidant inhibitor, and light stabilizer are added, an added amount is preferably 0.05 through 20 wt % to a binder resin in the added layer, more preferably 0.05 through 10 wt %. If the added amount is 20 wt % or more, the effect of a binder may be lowered, and the function of each layer may deteriorates. If the added amount is 0.05 wt % or less, the additives do not function.

<Optical Variable Device and Hologram Layer>

An optical variable device layer can be provided for the prevention of falsification or modification. Optical variable device (OVD) includes 1) kinegram, which is a two-dimensional CG image of diffraction grating and of which characteristic is that the image consisting of lines moves and changes freely including rotation, expansion and reduction, 2) pixelgram, which is characteristic of the change of image from positive to negative and vice versa, 3) OSD (optical security device), of which color change from gold to green, 4) LEAD (long lasting economical anticopy device), of which image looks variable, 5) stripe type OVD, and 6) metallic foil. Security may also be ensured by using special paper material, special printing technique and/or special ink as described in “Printing Association Journal of Japan” (1998) Vol. 35, No. 6, pages 482-496. Well-known technology as the cholesteric liquid crystal disclosed in the Japanese Application Patent Laid-open Publication Nos. HEI 11-256147 (1999), 2000-296700, and 2001-514319 is also applicable. In this invention, hologram is particularly preferred.

In case hologram is employed, any one of laser readout holograms such as relief hologram, Fresnel hologram, Fraunhofer hologram, lensless Fourier transform hologram, and image hologram, monochrome readout holograms such as Lippmann hologram and rainbow hologram, color hologram, computer hologram, hologram display, multiflex hologram, hologram flex-stereogram, and holographic diffraction grating.

<Method of Forming Authentication Recording Medium>

Using one or more of the sublimation recording materials and melting recording materials, a mirror-symmetric image is transferred onto the intermediate transfer medium of the image receiving sheet by the thermal recording such as a thermal head method, and the intermediate transfer medium is then transferred again and recorded onto the authentication recording medium. After this process, the intermediate transfer medium is peeled off, that is, the support constituting the intermediate transfer medium is peeled off, and the image is now formed there. A concrete method is described hereunder.

<Method of Forming Authentication Recording Medium>

An embodiment of the present invention is a method of producing authentication recording medium comprising a recording layer forming process for forming a face image recording layer or personal information recording layer on the first image receiving sheet by at least one of the (a) sublimation recording method and (b) melting recording method; then a substrate scattering light preventing layer forming process for forming a substrate light-scattering preventing layer of 0.3 to 100 μm thick; then the first transfer process for transferring the face image recording layer or personal information recording layer and substrate light-scattering preventing layer, both formed on the first image receiving sheet, onto the substrate of the authentication recording medium having the center-line average roughness (Ra) of 0.5 to 80.0 μm; and then a process for forming a hologram layer on the substrate of the authentication recording medium.

When thermal head is employed in this invention, it is preferable in forming an image that the sublimation recording material and melting recording material for thermal transfer recording and the image receiving layer are put together and pressurized in a range of 0.3 to 0.01 kg/cm² in accordance with recording signal and that mirror-symmetric image pattern is printed under a head temperature of 50 to 500° C. More preferable pressure is 0.25 to 0.01 kg/cm , and further more preferable is 0.25 to 0.02 kg/cm². More preferable head temperature to form an image containing gradation information is 100 to 500° C. or 100 to 400° C. Material for the image receiving sheet is not limited and any is applicable so far as the object of the invention is not hindered.

The method of forming an adhesion layer of the paper substrate for authentication recording medium on the face image recording layer or personal information recording layer of the present invention by the thermal transfer method or the like can be a thermal head method, laser method, or heat roll method. The thermal head method and heat roll method are particularly preferable in this invention for excellent maintainability.

When a thermal head method is employed, preferable heat print condition for this invention is 0.1 to 1.0 W/dot, pulse width of 0.3 to 5.0 msec, and dot density of 10 to 20 dot/mm.

If the adhesion layer material of the substrate for the authentication recording medium is light-curing adhesive, light source can be employed so as to improve the aggregation of the adhesion layer for substrate light-scattering prevention or adhesion with the substrate, and light can be applied either before or after the transfer onto the paper substrate for the authentication recording medium without limitation. An adhesion layer for the authentication recording medium can be formed on the image recording layer or personal information recording layer by a method for forming the substrate light-scattering preventing layer using a thermal transfer method.

The method of forming an authentication recording medium is to form the face image recording layer or personal information recording layer, on which the adhesion layer of the paper substrate for the authentication recording medium is formed, on the paper substrate for the authentication recording medium by transfer and/or peeling at least one time or more by means of a thermal head method, laser method, heat roll method or hot stamp machine. In the present invention, the heat roll method and hot stamp machine are particularly preferable for excellent maintainability.

When a hot stamp machine is employed, for example, preferable heating temperature is 10 to 250.° C., and 30 to 250° C. is more preferable and 50 to 220° C. is further more preferable. If it exceeds 250° C., there arises a problem that the paper substrate for the authentication recording medium is deformed by the heat. If it is less than 10° C., there also arises a problem that sufficient adhesion cannot be attained. Preferable pressure is 0.01 to 300 kgf/cm², and 0.01 to 200 kgf/cm² is more preferable and 0.03 to 200 kgf/cm² is further more preferable. Preferable heating and pressurizing time is 0.001 to 180 sec, and 0.05 to 180 sec is more preferable and 0.05 to 120 sec is further more preferable. Longer time than this results in lower production efficiency.

Compressive material used for the above can be any of rubber, silicone, fluorine-contained resin, or metal, but rubber and silicone are preferable because of excellent follow-up to the paper substrate for the authentication recording medium. Preferably, in order to peel off unnecessary portion from the transferred layer after the transfer, well-known peeling method such as peel-off bar method or take-up tension method can be employed. While transfer by the above transfer method shall be carried out at least once or more in the present invention, it can be repeated several times so as to improve the falsification or modification preventive characteristic.

### Embodiment of the Invention

An apparatus for producing an authentication recording medium, an authentication recording-medium producing method, and an authentication recording medium according to an example of the present invention are explained based on drawings. Incidentally, in an example, a substrate light scattering prevention layer may be called an authentication recording-medium printing paper substrate adhesive layer or an adhesive layer.

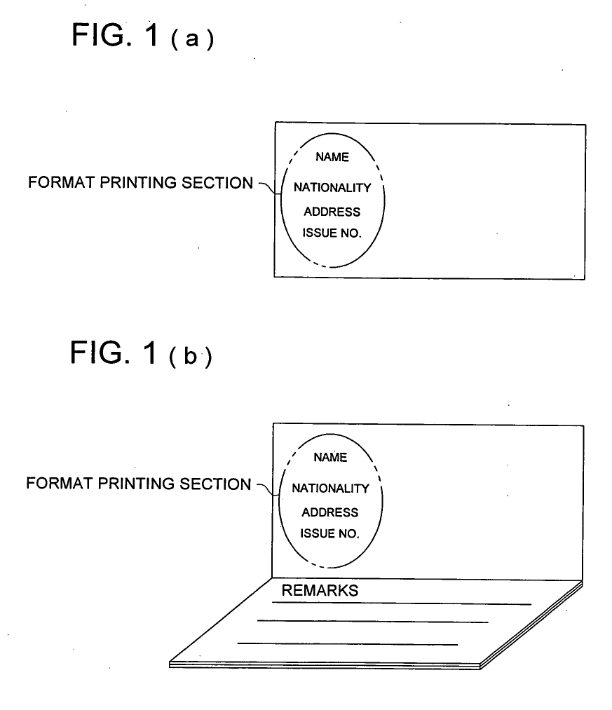

FIG. 1(a) and FIG. 1(b) show an typical example of the authentication recording-medium printing paper substrate usable for the invention.
(a) shows an authentication recording-medium printing paper substrate on which a format printing has been applied beforehand. (b) shows an authentication recording-medium printing paper substrate in a form of booklet on which a format printing has been applied beforehand.

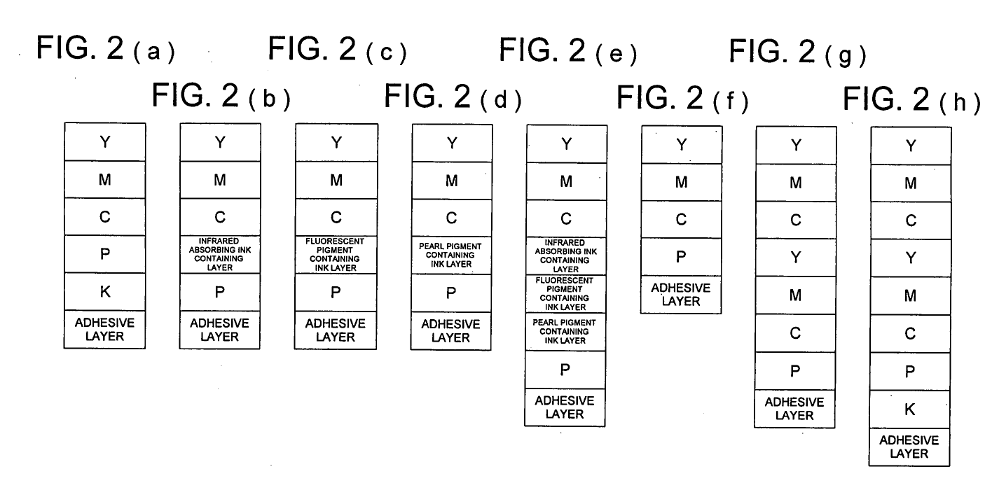

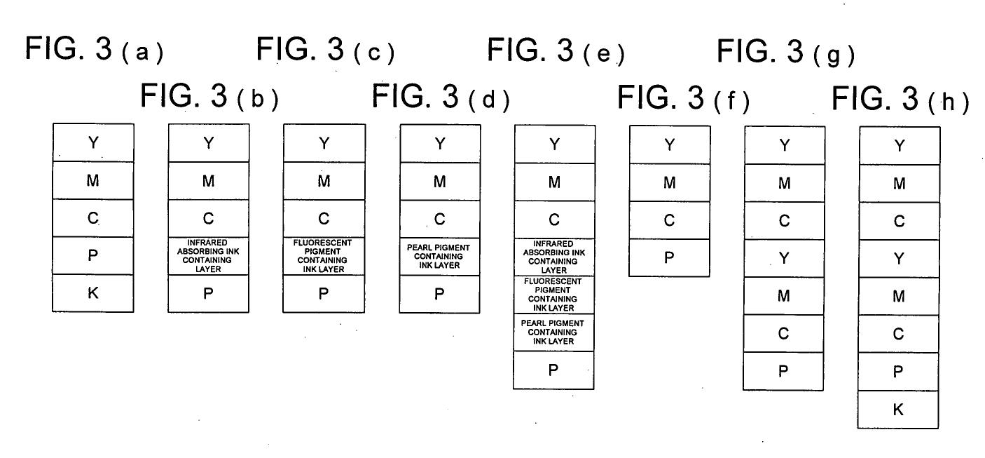

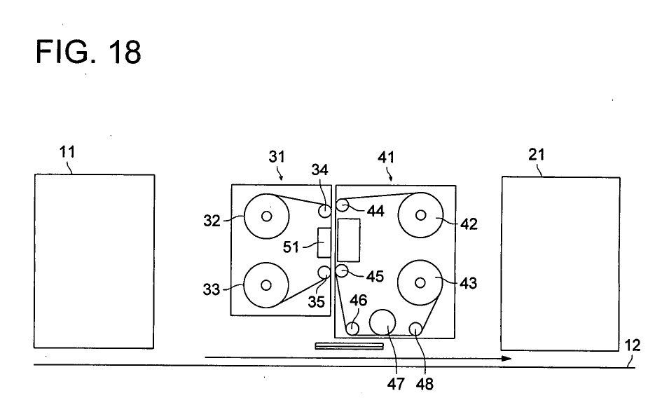

FIG. 2(a) to FIG. 2(h) and FIG. 3(a) to FIG. 3(h) show an typical example of a face image recording layer or a personal information recording layer forming material usable for the invention. FIG. 2(a) to FIG. 2(h) are explained here. Incidentally, FIG. 2(a) to FIG. 2(h) show a material usable for a unit 31 depicted in FIG. 18 to FIG. 21.

In FIG. 2(a), a face image recording layer or a personal information recording layer forming material is arranged in the surface order on a support.

An yellow sublimation dye containing layer Y, a magenta sublimation dye layer M, a cyan sublimation dye layer C, an after-heating layer P, a black melting pigment layer K, and an adhesive layer are arranged.

In FIG. 2(b), a face image recording layer or a personal information recording layer forming material is arranged in the surface order on a support.

An yellow sublimation dye containing layer Y, a magenta sublimation dye layer M, a cyan sublimation dye layer C, an infrared absorbing ink containing layer, an after-heating layer P, and an adhesive layer are arranged.

In FIG. 2(c), a face image recording layer or a personal information recording layer forming material is arranged in the surface order on a support.

An yellow sublimation dye containing layer Y, a magenta sublimation dye layer M, a cyan sublimation dye layer C, a fluorescent pigment containing layer, an after-heating layer P, and an adhesive layer are arranged.

In FIG. 2(d), a face image recording layer or a personal information recording layer forming material is arranged in the surface order on a support.

An yellow sublimation dye containing layer Y, a magenta sublimation dye layer M, a cyan sublimation dye layer C, a pearl pigment containing layer, an after-heating layer P, and an adhesive layer are arranged.

In FIG. 2(e), a face image recording layer or a personal information recording layer forming material is arranged in the surface order on a support.

An yellow sublimation dye containing layer Y, a magenta sublimation dye layer M, a cyan sublimation dye layer C, an infrared absorbing ink containing layer, a fluorescent pigment containing layer, a pearl pigment containing layer, an after-heating layer P, and an adhesive layer are arranged.

In FIG. 2(f), a face image recording layer or a personal information recording layer forming material is arranged in the surface order on a support.

An yellow sublimation dye containing layer Y, a magenta sublimation dye layer M, a cyan sublimation dye layer C, an after-heating layer P, and an adhesive layer are arranged.

In FIG. 2(f), a face image recording layer or a personal information recording layer forming material is arranged in the surface order on a support.

An yellow sublimation dye containing layer Y, a magenta sublimation dye layer M, a cyan sublimation dye layer C, a falsification preventing yellow sublimation dye containing layer Y, a falsification preventing magenta sublimation dye layer M, a falsification preventing cyan sublimation dye layer C, after-heating layer P, and an adhesive layer are arranged.

In FIG. 2(f), a face image recording layer or a personal information recording layer forming material is arranged in the surface order on a support.

An yellow sublimation dye containing layer Y, a magenta sublimation dye layer M, a cyan sublimation dye layer C, a falsification preventing yellow sublimation dye containing layer Y, a falsification preventing magenta sublimation dye layer M, a falsification preventing cyan sublimation dye layer C, after-heating layer P, a black melting pigment layer K, and an adhesive layer are arranged.

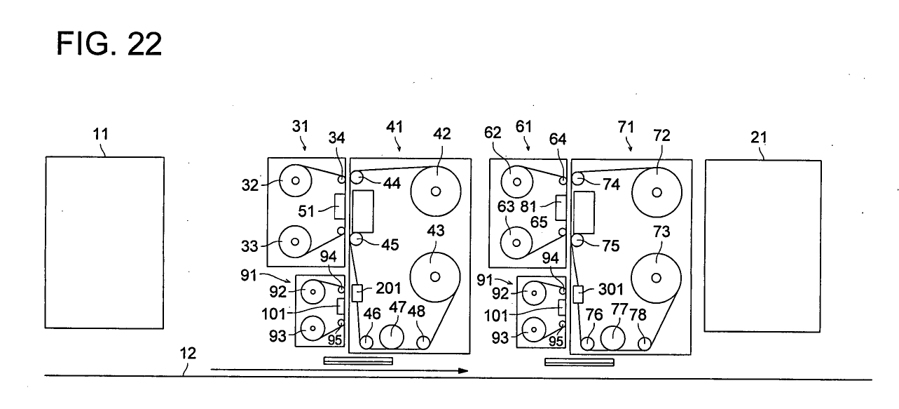

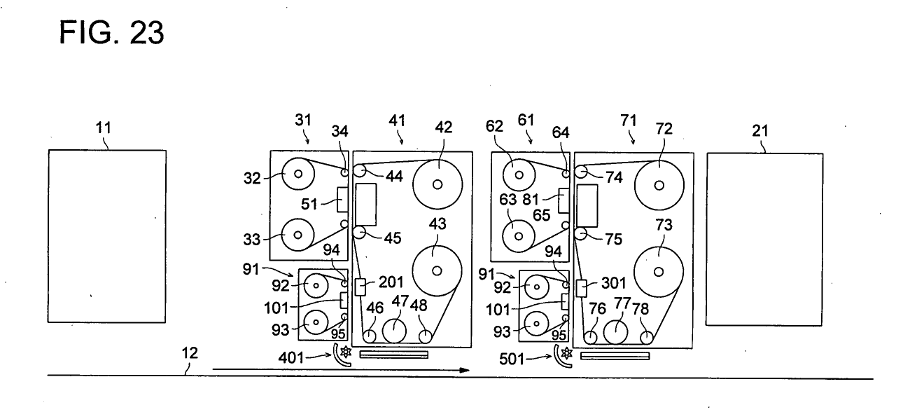

FIG. 3(a) to FIG. 3(h) are explained here. Incidentally, FIG. 3(a) to FIG. 3(h) show a material usable for a unit 31 depicted in FIG. 22 and FIG. 23.

In FIG. 3(a), a face image recording layer or a personal information recording layer forming material is arranged in the surface order on a support.

An yellow sublimation dye containing layer Y, a magenta sublimation dye layer M, a cyan sublimation dye layer C, an after-heating layer P, a black melting pigment layer K, and an adhesive layer are arranged.

In FIG. 3(b), a face image recording layer or a personal information recording layer forming material is arranged in the surface order on a support.

An yellow sublimation dye containing layer Y, a magenta sublimation dye layer M, a cyan sublimation dye layer C, an infrared absorbing ink containing layer, an after-heating layer P, and an adhesive layer are arranged.

In FIG. 3(c), a face image recording layer or a personal information recording layer forming material is arranged in the surface order on a support.

An yellow sublimation dye containing layer Y, a magenta sublimation dye layer M, a cyan sublimation dye layer C, a fluorescent pigment containing layer, an after-heating layer P, and an adhesive layer are arranged.

In FIG. 3(d), a face image recording layer or a personal information recording layer forming material is arranged in the surface order on a support.

An yellow sublimation dye containing layer Y, a magenta sublimation dye layer M, a cyan sublimation dye layer C, a pearl pigment containing layer, an after-heating layer P, and an adhesive layer are arranged.

In FIG. 3(e), a face image recording layer or a personal information recording layer forming material is arranged in the surface order on a support.

An yellow sublimation dye containing layer Y, a magenta sublimation dye layer M, a cyan sublimation dye layer C, an infrared absorbing ink containing layer, a fluorescent pigment containing layer, a pearl pigment containing layer, an after-heating layer P, and an adhesive layer are arranged.

In FIG. 3(f), a face image recording layer or a personal information recording layer forming material is arranged in the surface order on a support.

An yellow sublimation dye containing layer Y, a magenta sublimation dye layer M, a cyan sublimation dye layer C, an after-heating layer P, and an adhesive layer are arranged.

In FIG. 3(g), a face image recording layer or a personal information recording layer forming material is arranged in the surface order on a support.

An yellow sublimation dye containing layer Y, a magenta sublimation dye layer M, a cyan sublimation dye layer C, a falsification preventing yellow sublimation dye containing layer Y, a falsification preventing magenta sublimation dye layer M, a falsification preventing cyan sublimation dye layer C, an after-heating layer P, and an adhesive layer are arranged.

In FIG. 3(h), a face image recording layer or a personal information recording layer forming material is arranged in the surface order on a support.

An yellow sublimation dye containing layer Y, a magenta sublimation dye layer M, a cyan sublimation dye layer C, a falsification preventing yellow sublimation dye containing layer Y, a falsification preventing magenta sublimation dye layer M, a falsification preventing cyan sublimation dye layer C, an after-heating layer P, a black melting pigment layer K, and an adhesive layer are arranged.

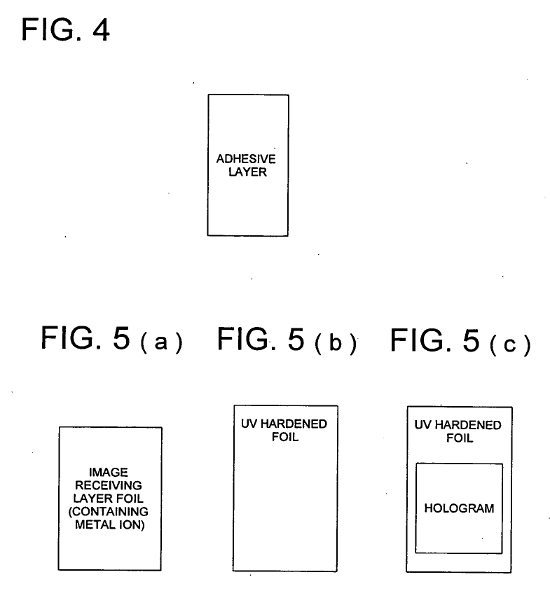

FIG. 4 shows a layer structure of an authentication recording-medium paper substrate adhesive layer forming material. In FIG. 4, a material can be used for a unit 91 depicted in FIG. 22 and FIG. 23.

FIG. 5(a) to FIG. 5(c) show a typical example of an image-receiving sheet usable for this invention.

FIG. 5(a) shows an image-receiving sheet made of a metal ion containing compound to form chelate by reacting with a thermal-diffusion dye.

FIG. 5(b) shows an image-receiving sheet made of a photo-curing layer.

FIG. 5(c) shows an image-receiving sheet made of a photo-curing layer and a hologram forming layer.

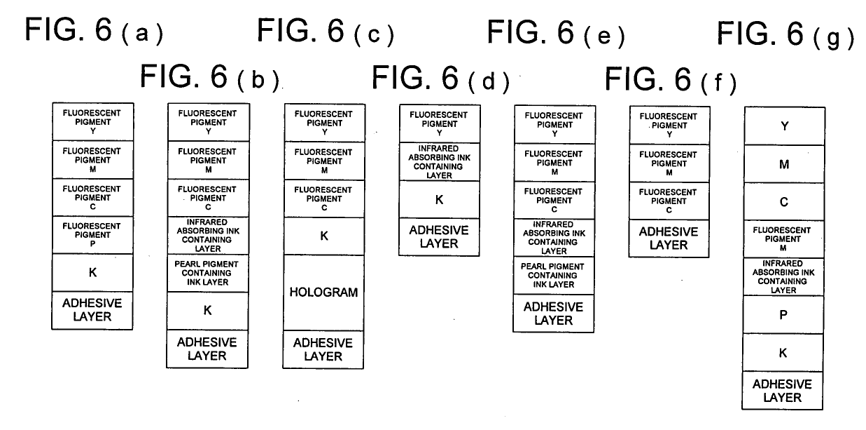

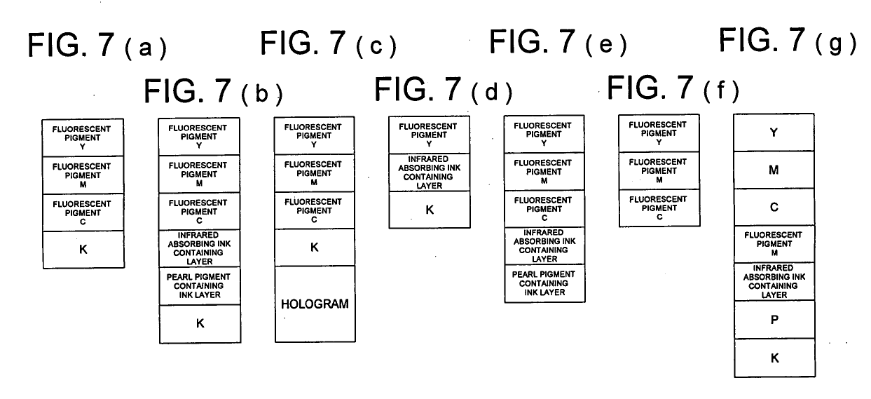

FIG. 6(a) to FIG. 6(g), and FIG. 7(a) to FIG. 7(g) show a typical example of a falsification preventing layer forming material made of a) a sublimation dye, b) a melting ink, d) a fluorescent agent, e) infrared absorbent, f) pearl pigment, g) an optical change element, or, a hologram.

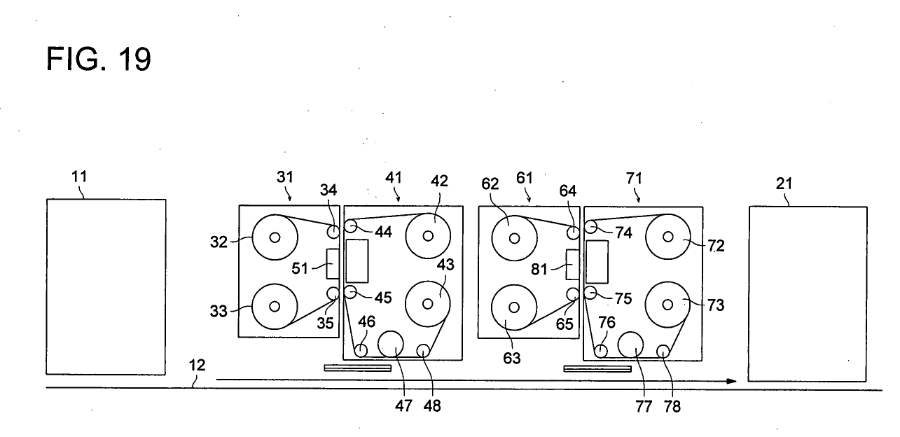

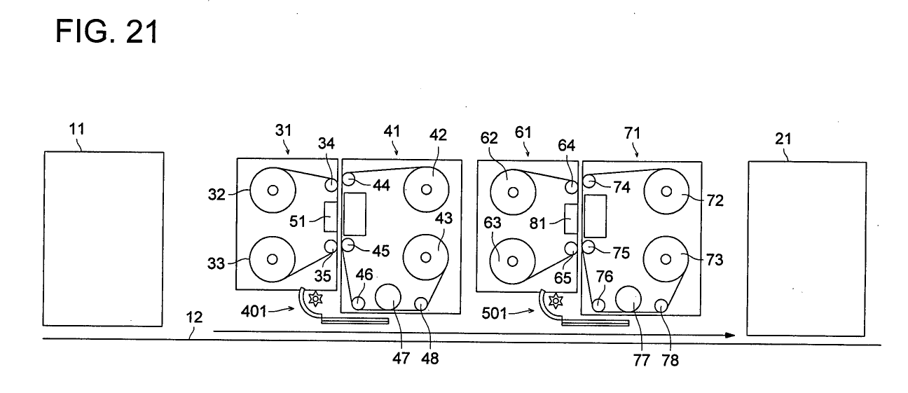

Firstly, FIG. 6(a) to FIG. 6(g) are explained. Incidentally, FIG. 6(a) to FIG. 6 (g) show a material usable for a unit 71 depicted in FIG. 19 and FIG. 21.

In FIG. 6(a), a falsification preventing layer forming material is arranged in the surface order on a support.

An yellow fluorescent pigment containing layer Y, a magenta fluorescent pigment containing layer M, a cyan fluorescent pigment containing layer C, a black melting pigment layer K, and an adhesive layer are arranged.

In FIG. 6(b), a falsification preventing layer forming material is arranged in the surface order on a support.

An yellow fluorescent pigment containing layer Y, a magenta fluorescent pigment containing layer M, a cyan fluorescent pigment containing layer C, an infrared absorbing ink containing layer, a pearl pigment containing layer, a black melting pigment layer K, and an adhesive layer are arranged.

In FIG. 6(c), a falsification preventing layer forming material is arranged in the surface order on a support.

An yellow fluorescent pigment-containing layer Y, a magenta fluorescent pigment containing layer M, a cyan fluorescent pigment containing layer C, a black melting pigment layer K, a hologram layer and an adhesive layer are arranged.

In FIG. 6(d), a falsification preventing layer forming material is arranged in the surface order on a support.

An yellow fluorescent pigment containing layer Y, an infrared absorbing ink containing layer, a black melting pigment layer K, and an adhesive layer are arranged.

In FIG. 6(e), a falsification preventing layer forming material is arranged in the surface order on a support.

An yellow fluorescent pigment containing layer Y, a magenta fluorescent pigment containing layer M, a cyan fluorescent pigment containing layer C, an infrared absorbing ink containing layer, a pearl pigment containing layer, and an adhesive layer are arranged.

In FIG. 6(f), a falsification preventing layer forming material is arranged in the surface order on a support.

An yellow fluorescent pigment containing layer Y, a magenta fluorescent pigment containing layer M, a cyan fluorescent pigment containing layer C, and an adhesive layer are arranged.

In FIG. 6(g), a falsification preventing layer forming material is arranged in the surface order on a support.

A falsification preventing yellow sublimation dye containing layer Y, a falsification preventing magenta sublimation dye layer M, a falsification preventing cyan sublimation dye layer C, a magenta fluorescent pigment containing layer M, an infrared absorbing ink containing layer, an after-heating layer P, a black melting pigment layer K, and an adhesive layer are arranged.

FIG. 7(a) to FIG. 7(g) are explained. Incidentally, FIG. 7(a) to FIG. 7(g) show-a material usable for a unit 71 depicted in FIG. 22 and FIG. 23.

In FIG. 7(a), a falsification preventing layer forming material is arranged in the surface order on a support.

An yellow fluorescent pigment containing layer Y, a magenta fluorescent pigment containing layer M, a cyan fluorescent pigment containing layer C, and a-black melting pigment layer K are arranged.

In FIG. 7(a), a falsification preventing layer forming material is arranged in the surface order on a support.

An yellow fluorescent pigment containing layer Y, a magenta fluorescent pigment containing layer M, a cyan fluorescent pigment containing layer C, an infrared absorbing ink containing layer, a pearl pigment containing layer, and a black melting pigment layer K are arranged.

In FIG. 7(c), a falsification preventing layer forming material is arranged in the surface order on a support.

An yellow fluorescent pigment containing layer Y, a magenta fluorescent pigment containing layer M, a cyan fluorescent pigment containing layer C, a black melting pigment layer K and a hologram layer are arranged.

In FIG. 7(d), a falsification preventing layer forming material is arranged in the surface order on a support.

An yellow fluorescent pigment containing layer Y, an infrared absorbing ink containing layer, and a black melting pigment layer K are arranged.

In FIG. 7(e), a falsification preventing layer forming material is arranged in the surface order on a support.

An yellow fluorescent pigment containing layer Y, a magenta fluorescent pigment containing layer M, a cyan fluorescent pigment containing layer C, an infrared absorbing ink containing layer, and a pearl pigment containing layer are arranged.

In FIG. 7(f), a falsification preventing layer forming material is arranged in the surface order on a support.

An yellow fluorescent pigment containing layer Y, a magenta fluorescent pigment containing layer M, and a cyan fluorescent pigment containing layer C are arranged.

In FIG. 7(g), a falsification preventing layer forming material is arranged in the surface order on a support.

A falsification preventing yellow sublimation dye containing layer Y, a falsification preventing magenta sublimation dye layer M, a falsification preventing cyan sublimation dye layer C, a magenta fluorescent pigment containing layer M, an infrared absorbing ink containing layer, an after-heating layer P, and a black melting pigment layer K are arranged.

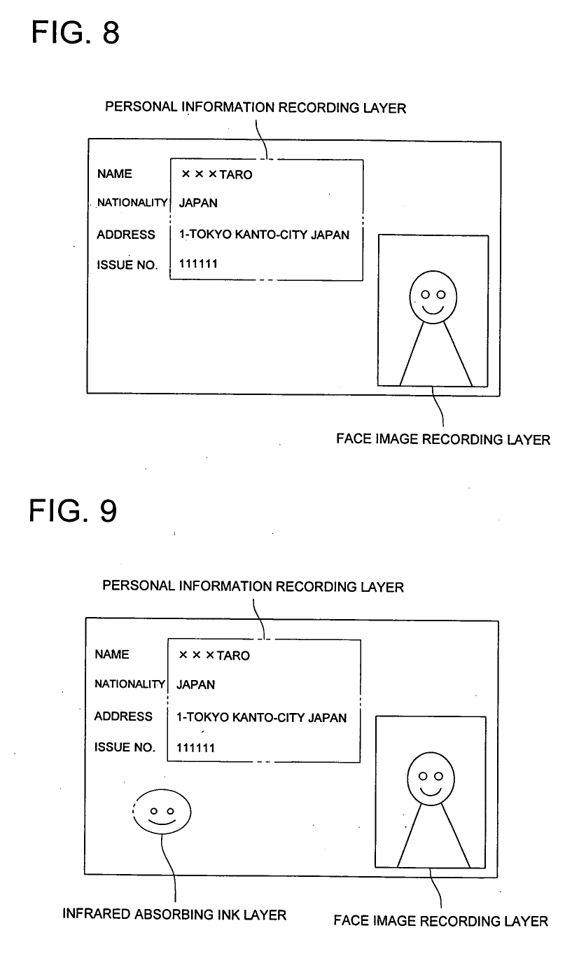

FIG. 8 to FIG. 17 show a typical example of an authentication recording medium produced by this invention.

FIG. 8 is a perspective view in which a personal information recording layer and a face image recording layer are printed on a substrate of an authentication recording media of FIG. 1(a) and FIG. 1(b).

FIG. 9 is a perspective view in which a personal information recording layer and a face image recording layer are printed on a substrate of an authentication recording media of FIG. 1(a) and FIG. 1(b) and an infrared absorbing ink containing layer for preventing falsification is formed.

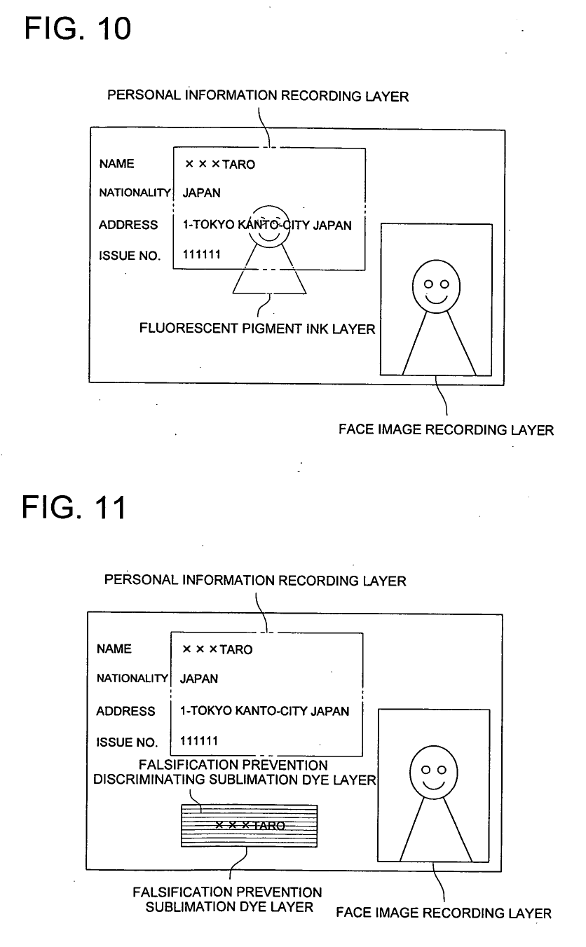

FIG. 10 is a perspective view in which a personal information recording layer and a face image recording layer are printed on a substrate of an authentication recording media of FIG. 1(a) and FIG. 1(b) and a fluorescent pigment ink layer for preventing falsification is formed.

FIG. 11 is a perspective view in which a personal information recording layer and a face image recording layer are printed on a substrate of an authentication recording media of FIG. 1(a) and FIG. 1(b) and a falsification and modification preventing sublimation dye layer and a falsification and modification prevention discriminating sublimation dye layer are formed. Incidentally, the falsification and modification preventing sublimation dye layer and the falsification and modification prevention discriminating sublimation dye layer are made such an embodiment that they are printed with the same color tone and density on a visual observation and can not be discriminated if a scanner has not a specific wavelength.

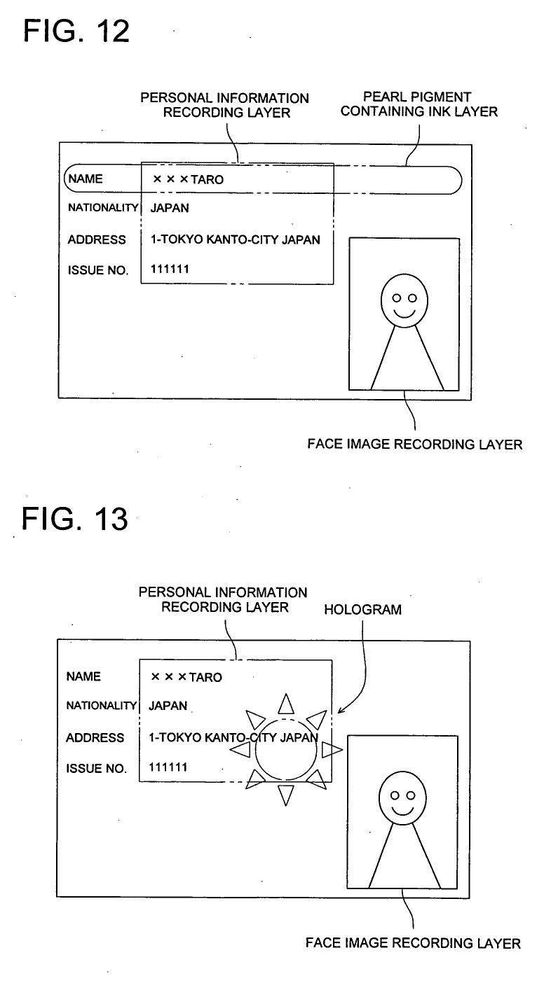

FIG. 12 is a perspective view in which a personal information recording layer and a face image recording layer are printed on a substrate of an authentication recording media of FIG. 1(a) and FIG. 1(b) and a pearl ink containing layer for preventing falsification and modification is formed.

FIG. 13 is a perspective view in which a personal information recording layer and a face image recording layer are printed on a substrate of an authentication recording media of FIG. 1(a) and FIG. 1(b) and a hologram layer for preventing falsification and modification is formed.

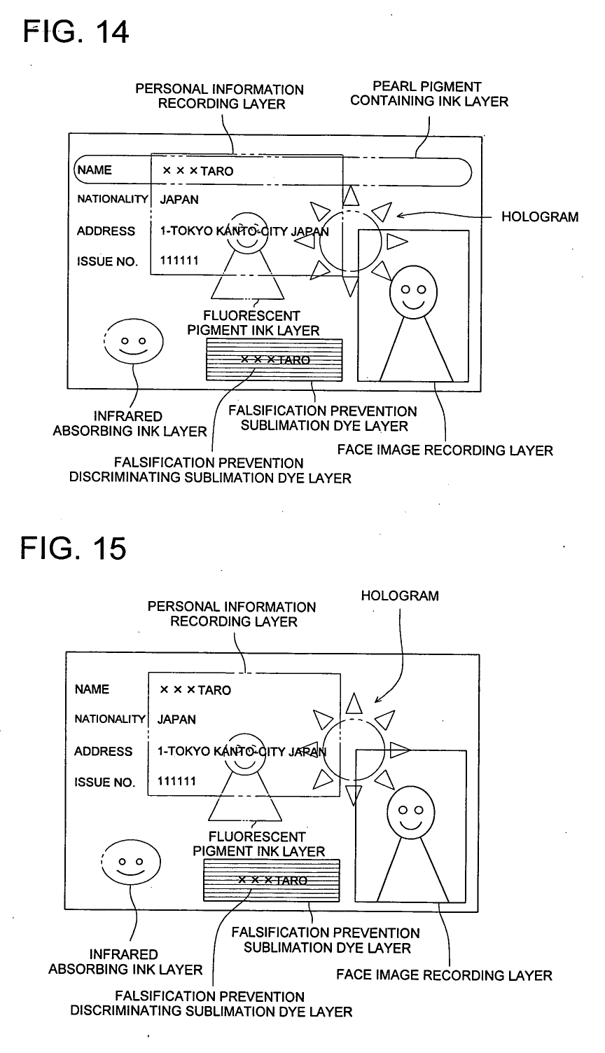

FIG. 14 is a perspective view in which a personal information recording layer and a face image recording layer are printed on a substrate of an authentication recording media of FIG. 1(a) and FIG. 1(b) and an infrared absorbing ink containing layer, a fluorescent pigment ink layer, a falsification and modification preventing sublimation dye layer, a falsification and modification prevention discriminating sublimation dye layer, a pearl ink containing layer, and a hologram layer for preventing falsification and modification are formed. Incidentally, the falsification and modification preventing sublimation dye layer and the falsification and modification prevention discriminating sublimation dye layer are made such an embodiment that they are printed with the same color tone and density on a visual observation and can not be discriminated if a scanner has not a specific wavelength.

FIG. 15 is a perspective view in which a personal information recording layer and a face image recording layer are printed on a substrate of an authentication recording media of FIG. 1(a) and FIG. 1(b) and an infrared absorbing ink containing layer, a fluorescent pigment ink layer, a falsification and modification preventing sublimation dye layer, a falsification and modification prevention discriminating sublimation dye layer, and a hologram layer for preventing falsification and modification are formed. Incidentally, the falsification and modification preventing sublimation dye layer and the falsification and modification prevention discriminating sublimation dye layer are made such an embodiment that they are printed with the same color tone and density on a visual observation and can not be discriminated if a scanner has not a specific wavelength.

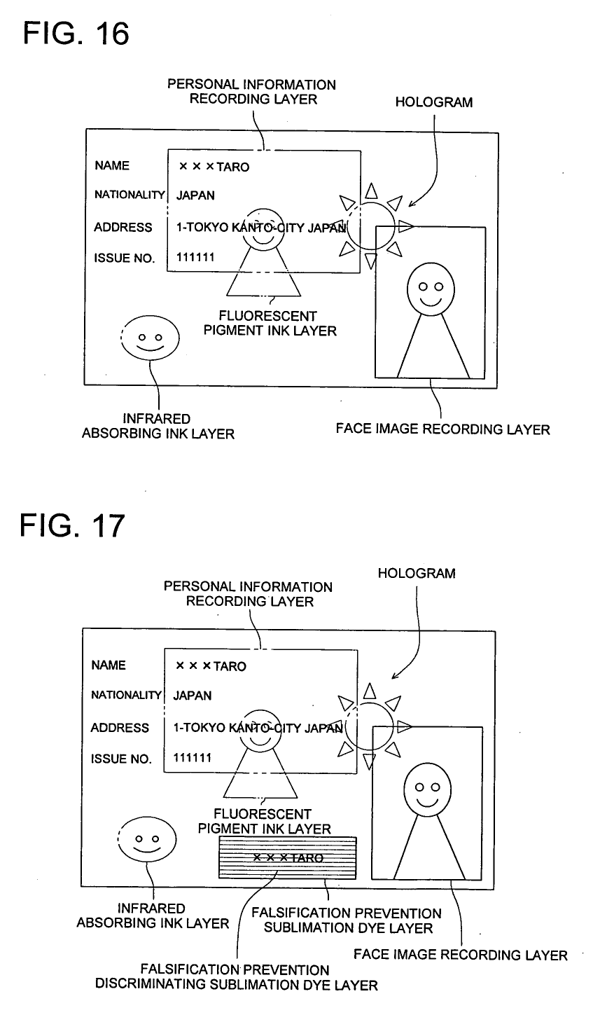

FIG. 16 is a perspective view in which a personal information recording layer and a face image recording layer are printed on a substrate of an authentication recording media of FIG. 1(a) and FIG. 1(b) and an infrared absorbing ink containing layer, a fluorescent pigment ink layer, and a hologram layer for preventing falsification and modification are formed.

FIG. 17 is a perspective view in which a personal information recording layer and a face image recording layer are printed on a substrate of an authentication recording media of FIG. 1(a) and FIG. 1(b) and an infrared absorbing ink containing layer, a falsification and modification preventing sublimation dye layer, a falsification and modification prevention discriminating sublimation dye layer, and a hologram layer for preventing falsification and modification are formed. Incidentally, the falsification and modification preventing sublimation dye layer and the falsification and modification prevention discriminating sublimation dye layer are made such an embodiment that they are printed with the same color tone and density on a visual observation and can not be discriminated if a scanner has not a specific wavelength.

FIG. 18 to FIG. 23 show a typical example of an authentication recording media issuing apparatus usable in this invention.

FIG. 18 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an image receiving sheet transferring unit 41 and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section to roll up a printed image recording layer and a printed personal information recording layer forming material, a conveying roll 34 and a peeling roll 25.

The image receiving sheet transferring unit 41 is structured by a collecting section 42 to collect an image receiving sheet material of FIG. 5(a) to FIG. 5(c), a rolling up section to roll up an image receiving sheet, a conveying roll 44, a conveying roll 45, a conveying roll 46, a transfer process to heat and press an image recording layer, a personal information recording layer forming material or a base material adhesive layer of an authentication recording media onto a base material of an authentication recording media by a heat roll 47, and a peeling roll 48 to peel a transfer-unrequired portion from a transfer portion after the transfer process. Finally, an authentication recording media of either one embodiment of FIG. 8 to FIG. 17 is produced.

FIG. 19 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an image receiving sheet transferring unit 41, a recording unit 61, an image receiving sheet transferring unit 71, and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section 33 to roll up a printed image recording layer or a printed personal information recording layer forming material, a conveying roll 34 and a peeling roll 25.

The image receiving sheet transferring unit 41 is structured by a collecting section 42 to collect an image receiving sheet material of FIG. 5(a) to FIG. 5(c), a rolling up section 43 to roll up an image receiving sheet, a conveying roll 44, a conveying roll 45, a conveying roll 46, a transfer process to heat and press an image recording layer printed on an image receiving sheet by the recording unit, a personal information recording layer forming material or a base material adhesive layer of an authentication recording media onto a base material of an authentication recording media by a heat roll 47, and a peeling roll 48 to peel a transfer-unrequired portion from a transfer portion after the transfer process.

The recording unit 31 is structure by a collecting section 62 to collect a falsification preventing layer forming material of FIG. 6(a) to FIG. 6(g) and FIG. 7(a) to FIG. 7(g), a thermal head recording section 81, a rolling-up section 63 to roll up a falsification preventing layer forming material made of a) a sublimation dye, b) a melting ink, d) a fluorescent agent, e) an infrared absorbent, f) a pearl pigment, g) an optical change element, or a hologram, a conveying roll 64 and a peeling roll 65.

The image receiving sheet transferring unit 71 is structured by a collecting section 72 to collect an image receiving sheet material of FIG. 5(a) to FIG. 5(c), a rolling up section 73 to roll up an image receiving sheet, a conveying roll 74, a conveying roll 55, a conveying roll 76. Further, it is structured by a transfer process to heat and press a falsification and modification preventing layer forming material printed on an image recording layer by the recording unit onto an intermediate media of a paper base material for an authentication recording media by a heat roll 77, and a peeling roll 78 to peel a transfer-unrequired portion from a transfer portion after the transfer process. Finally, an authentication recording media of either one embodiment of FIG. 18 to FIG. 17 is produced.

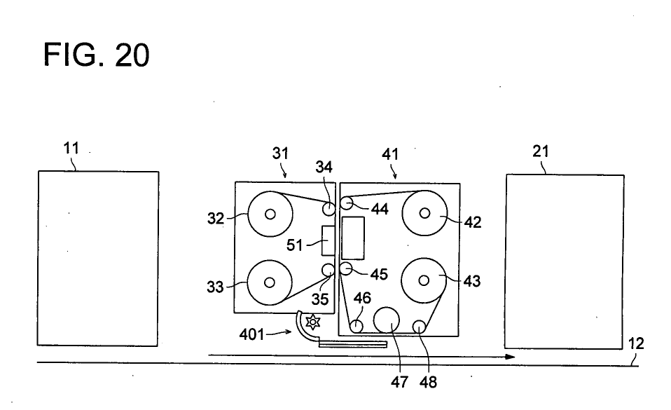

FIG. 20 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an image receiving sheet transferring unit 41, a metal halide irradiation section 401 and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section 33 to roll up a printed image recording layer or a printed personal information recording layer forming material, a conveying roll 34 and a peeling roll 25.

The image receiving sheet transferring unit 41 is structured by a collecting section 42 to collect an image receiving sheet material of FIG. 5(a) to FIG. 5(c), a rolling up section 43 to roll up an image receiving sheet, a conveying roll 44, a conveying roll 45, a conveying roll 46, a transfer process to expose a surface of an image recording layer printed on an image receiving material by the recording unit, a personal information recording layer forming material or a base material adhesive layer of an authentication recording media with the metal halide irradiating section 401, then heat and press onto a base material of an authentication recording media by a heat roll 47, and a peeling roll 48 to peel a transfer-unrequired portion from a transfer portion after the transfer process. Finally, an authentication recording media of either one embodiment of FIG. 18 to FIG. 17 is produced.

FIG. 21 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an image receiving sheet transferring unit 41, a metal halide irradiation section 501 and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section 33 to roll up a printed image recording layer or a printed personal information recording layer forming material, a conveying roll 34 and a peeling roll 25.

The image receiving sheet transferring unit 41 is structured by a collecting section 42 to collect an image receiving sheet material of FIG. 5(a) to FIG. 5(c), a rolling up section 43 to roll up an image receiving sheet, a conveying roll 44, a conveying roll 45, a conveying roll 46, a transfer process to expose a surface of an image recording layer printed on an image receiving material by the recording unit, a personal information recording layer forming material or a base material adhesive layer of an authentication recording media with the metal halide irradiating section 401, then heat and press onto a base material of an authentication recording media by a heat roll 47, and a peeling roll 48 to peel a transfer-unrequired portion from a transfer portion after the transfer process.

The recording unit 61 is structure by a collecting section 62 to collect a falsification preventing layer forming material of FIG. 6(a) to FIG. 6(g) and FIG. 7(a) to FIG. 7(g), a thermal head recording section 81, a rolling-up section 63 to roll up a falsification preventing layer forming material made of a) a sublimation dye, b) a melting ink, d) a fluorescent agent, e) an infrared absorbent, f) a pearl pigment, g) an optical change element, or a hologram, a conveying roll 64 and a peeling roll 65.

The image receiving sheet transferring unit 71 is structured by a collecting section 72 to collect an image receiving sheet material of FIG. 5(a) to FIG. 5(c)* a rolling up section 73 to roll up an image receiving sheet, a conveying roll 74, a conveying roll 55, a conveying roll 76. Further, it is structured by a transfer process to expose a falsification and modification preventing layer forming material printed on an image recording layer by the recording unit onto an intermediate media of a paper base material for an authentication recording media by the metal halide irradiating section 401, subsequently, to heat and press by a heat roll 77, and a peeling roll 78 to peel a transfer-unrequired portion from a transfer portion after the transfer process. Finally, an authentication recording media of either one embodiment of FIG. 8 to FIG. 17 is produced.

FIG. 22 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an image receiving sheet transferring unit 41, a recording unit 61, an authentication recording media paper base material adhesive layer providing unit 91, an image receiving sheet transferring unit 71 and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section 33 to roll up a printed image recording layer or a printed personal information recording layer forming material, a conveying roll 34 and a peeling roll 25.

The authentication recording media paper base material adhesive layer providing unit 91 is structured by at least a collecting section 92 to collect a thermal transfer ribbon having provided adhesive, a thermal head recording section 101, a rolling-up section 93 to roll up an adhesive forming material, a conveying roll 94 and a peeling roll 95.

The image receiving sheet transferring unit 41 is structured by a collecting section 42 to collect an image receiving sheet material of FIG. 5(a) to FIG. 5(c), a rolling up section 43 to roll up an image receiving sheet, a conveying roll 44, a conveying roll 45, a conveying roll 46, a transfer process to form an image recording layer printed on an image receiving sheet by the recording unit and an adhesive layer by the authentication recording media paper base material adhesive layer providing unit 91 and then to heat and press by a heat roll 47, and a peeling roll 48 to peel a transfer-unrequired portion from a transfer portion after the transfer process.

The recording unit 61 is structure by a collecting section 62 to collect a falsification preventing layer forming material of FIG. 6(a) to FIG. 6(g) and FIG. 7(a) to FIG. 7(g), a thermal head recording section 81, a rolling-up section 63 to roll up a falsification preventing layer forming material made of a) a sublimation dye, b) a melting ink, d) a fluorescent agent, e) an infrared absorbent, f) a pearl pigment, g) an optical change element, or a hologram, a conveying roll 64 and a peeling roll 65.

The authentication recording media paper base material adhesive layer providing unit 91 is structured by at least a collecting section 92 to collect a thermal transfer ribbon having provided adhesive, a thermal head recording section 101, a rolling-up section 93 to roll up an adhesive forming material, a conveying roll 94 and a peeling roll 95.

The image receiving sheet transferring unit 71 is structured by a collecting section 72 to collect an image receiving sheet material of FIG. 5(a) to FIG. 5(c), a rolling up section 73 to roll up an image receiving sheet, a conveying roll 74, a conveying roll 55, and a conveying roll 76. Further, it is structured by a transfer process to form an adhesive layer on a falsification and modification preventing layer forming material printed on an image receiving sheet by the recording unit by the authentication recording media paper base material adhesive layer providing unit 91, subsequently, to heat and press by a heat roll 77 onto an intermediate media of a paper base material for an authentication recording media formed by the previous process, and a peeling roll 78 to peel a transfer-unrequired portion from a transfer portion after the transfer process. Finally, an authentication recording media of either one embodiment of FIG. 8 to FIG. 17 is produced.

FIG. 23 shows an issuing apparatus comprising a collecting section 11 to collect either a base material for an authentication recording media of FIG. 1(a) or FIG. 1(b), a conveying section 12 for a base material for an authentication recording media, a recording unit 31 for a personal information recording layer and a face image recording layer, an authentication recording media paper base material adhesive layer providing unit 91, a metal halide irradiating section 401, an image receiving sheet transferring unit 71 and an authentication recording media stocker section 21.

The recording unit 31 is structure by a collecting section 32 to collect an image recording layer and a personal information recording layer forming material of FIG. 2(a) to FIG. 2(h) and FIG. 3(a) to FIG. 3(h), a thermal head recording section 51, a rolling-up section 33 to roll up a printed image recording layer or a printed personal information recording layer forming material, a conveying roll 34 and a peeling roll 25.

The authentication recording media paper base material adhesive layer providing unit 91 is structured by at least a collecting section 92 to collect a thermal transfer ribbon having provided adhesive, a thermal head recording section 101, a rolling-up section 93 to roll up an adhesive forming material, a conveying roll 94 and a peeling roll 95.

The image receiving sheet transferring unit 41 is structured by a collecting section 42 to collect an image receiving sheet material of FIG. 5(a) to FIG. 5(c), a rolling up section 43 to roll up an image receiving sheet, a conveying roll 44, a conveying roll 45, a conveying roll 46, a transfer process to form an image recording layer printed on an image receiving sheet by the recording unit and an adhesive layer on an authentication recording media paper base material by the authentication recording media paper base material adhesive layer providing unit 91 and then to heat and press by a heat roll 47 after irradiating on the surface of the authentication recording media paper base material adhesive layer by the metal halide irradiating section 401, and a peeling roll 48 to peel a transfer-unrequired portion from a transfer portion after the transfer process.

The recording unit 61 is structure by a collecting section 62 to collect a falsification preventing layer forming material of FIG. 6(a) to FIG. 6(g) and FIG. 7(a) to FIG. 7(g), a thermal head recording section 81, a rolling-up section 63 to roll up a falsification preventing layer forming material made of a) a sublimation dye, b) a melting ink, d) a fluorescent agent, e) an infrared absorbent, f,) a pearl pigment, g) an optical change element, or a hologram, a conveying roll 64 and a peeling roll 65.

The authentication recording media paper base material adhesive layer providing unit 91 is structured by at least a collecting section 92 to collect a thermal transfer ribbon having provided adhesive, a thermal head recording section 101, a rolling-up section 93 to roll up an adhesive forming material, a conveying roll 94 and a peeling roll 95.

The image receiving sheet transferring unit 71 is structured by a collecting section 72 to collect an image receiving sheet material of FIG. 5(a) to FIG. 5(c), a rolling up section 73 to roll up an image receiving sheet, a conveying roll 74, a conveying roll 75, a conveying roll 76. Further, it is structured by a transfer process to form an adhesive layer on a falsification and modification preventing layer forming material printed on an image recording layer by the recording unit by the authentication recording media paper base material adhesive layer providing unit 91, subsequently, after irradiating on the surface of the authentication recording media paper base material adhesive layer by the metal halide irradiating section 401, to heat and press by a heat roll 77 onto an intermediate media of a paper base material for an authentication recording media formed by the previous process and a peeling roll 78 to peel a transfer-unrequired portion from a transfer portion after the transfer process.

By the authentication recording-medium producing apparatus shown in FIGS. 18 to 23, it becomes possible to provide an apparatus which can make the production time shorter, can produce simply cheaply, and has a good maintenance capability, further, it becomes possible to produce an authentication recording medium with which a quality stability and a falsification and modification preventing capability are improved.

### EXAMPLE

(The Authentication Recording-Medium Paper Substrate Production Method)

<Authentication Recording-Medium Paper Substrate 1>

On a high-quality paper with a center line average roughness (Ra) of 50 μm, a format printing (a name, a nationality, an address, an issue No.) was provided by a typographic printing with a UV printing ink (FD-O-Japanese ink, manufactured by Naruto ink). The UV irradiation condition at the time of printing was equivalents for 200 mj with a high-pressure mercury vapor lamp.

<Authentication Recording-Medium Paper Substrate 2>

On the wood-free paper having a center line average roughness (Ra) of 100 μm, by the use of UV printing ink (floppy disk-O Japanese ink, manufactured by Naruto ink), there was prepared format printing (a name, nationality, address, issue No.) by typographic printing. UV irradiation condition at the time of printing was equivalents for 200 mj in the high-pressure mercury vapor lamp.

<Authentication Recording-Medium Printing Paper Substrate 3>

On the wood-free paper having a center line average roughness (Ra) of 0.2 μm, by the use of UV printing ink (floppy disk-O Japanese ink, Naruto ink manufactured by), there was prepared format printing (a name, nationality, address, issue No.) by typographic printing. The UV irradiation condition at the time of printing was equivalents for 200 mj in the high-pressure mercury vapor lamp.

<Authentication Recording-Medium Printing Paper Substrate 4>

On the wood-free paper which having a center line average roughness (Ra) of 5 μm, by the use of UV printing ink (floppy disk-O Japanese ink, Naruto ink manufactured by), there was prepared format printing (a name, nationality, address, issue No.) by typographic printing. The UV irradiation condition at the time of printing was equivalents to 200 mj in the high-pressure mercury vapor lamp.

(A face Image Recording Layer or Personal Information Recording Layer Production Material Production Method)

<A Face Image Recording Layer or Personal Information Recording Material 1>

An ink sheet including a face image recording layer or personal information recording layer production material was obtained in such a way that an yellow ink layer forming coating liquid, a magenta ink layer forming coating liquid, a cyan ink layer forming coating liquid and a black ink layer forming coating liquid having the following compositions respectively were provided in the surface order shown in the embodiment of FIG. 3(a) to make respective thickness to be 1 μm on a polyethylene terephthalate sheet which has a thickness of 6 μm and was subjected to a fusion prevention processing on its reverse side. Incidentally, P section given in FIG. 3(a) is a layer prepared in order to carry out after-heating, and represents a part for a non-coated portion in the present invention. A face image recording layer or a personal information recording material can be formed by the recording unit 31 of the issuing apparatus of FIG. 22 and FIG. 23 for a personal information recording layer or a face image recording layer.

A compound MS, a compound Y-1, a compound Y-2, a compound M-1, a compound M-2, a compound C-1, and a compound C-2 used for this example are shown below.

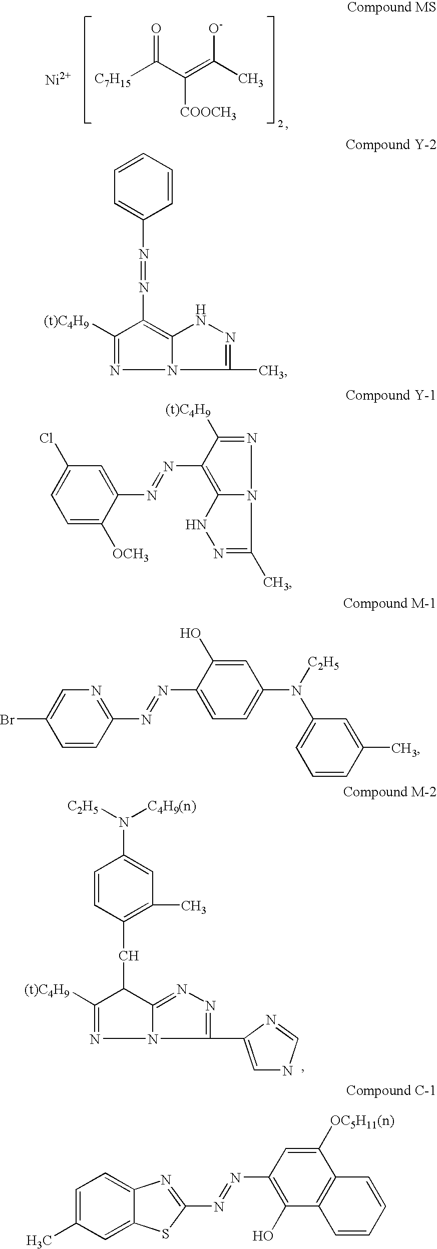

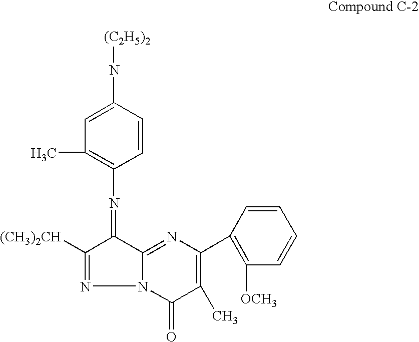

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane denaturation silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Black ink layer forming coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

<A face image recording layer or a personal information recording material 2>

An ink sheet including a face image recording layer or personal information recording layer production material was obtained in such a way that an yellow ink layer forming coating liquid, a magenta ink layer forming coating liquid, and a cyan ink layer forming coating liquid having the following compositions respectively were provided in the surface order shown in the embodiment of FIG. 3(f) to make respective thickness to be 1 μm on a polyethylene terephthalate sheet which has a thickness of 6 μm and was subjected to a fusion prevention processing on its reverse side. Incidentally, P section given in FIG. 3(f) is a layer prepared in order to carry out after-heating, and represents a part for a non-coated portion in the present invention. A face image recording layer or a personal information recording material can be formed by the recording unit 31 of the issuing apparatus of FIG. 22 and FIG. 23 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by DENKIKAGAKU- | | |
| KOGYO-KABUSHIKI-KAISHA] | | |
| Polymethyl metaacrylate modified polystyrene | 1 | parts |
| [REDEDA GP-200: manufactured by Toagosei | | |
| Chemical-industry Co., Ltd.] | | |
| Urethane modified silicone oil | 0.5 | parts |
| [DiaromaSP-2105: manufactured by Dainichiseika Industry | | |
| Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by DENKIKAGAKU- | | |
| KOGYO-KABUSHIKI-KAISHA] | | |
| Polymethyl metaacrylate modified polystyrene | 2 | parts |
| [REDEDA GP-200: manufactured by Toagosei | | |
| Chemical-industry Co., Ltd.] | | |
| Urethane modified silicone oil | 0.5 | parts |
| [DiaromaSP-2105: manufactured by Dainichiseika Industry | | |
| Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by DENKIKAGAKU- | | |
| KOGYO-KABUSHIKI-KAISHA] | | |
| Polymethyl metaacrylate modified polystyrene | 1 | parts |
| [REDEDA GP-200: manufactured by Toagosei | | |
| Chemical-industry Co., Ltd.] | | |
| Urethane modified silicone oil | 0.5 | parts |
| [DiaromaSP-2105: manufactured by Dainichiseika Industry | | |
| Co., Ltd.] | | |
| Methyl ethyl ketone | 70 | parts |
| Toluene | 20 | parts |

<A Face Image Recording Layer or a Personal Information Recording Material 3>

An ink sheet including a face image recording layer or personal information recording layer production material was obtained in such a way that an yellow ink layer forming coating liquid, a magenta ink layer forming coating liquid, and a cyan ink layer forming coating liquid, and an infrared absorption material containing layer forming coating liquid having the following compositions respectively were provided in the surface order shown in the embodiment of FIG. 3(b) to make respective thickness to be 1 μm on a polyethylene terephthalate sheet which has a thickness of 6 μm and was subjected to a fusion prevention processing on its reverse side. Incidentally, P section given in FIG. 3(b) is a layer prepared in order to carry out after-heating, and represents a part for a non-coated portion in the present invention. A face image recording layer or a personal information recording material can be formed by the recording unit 31 of the issuing apparatus of FIG. 22 and FIG. 23 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Infrared absorption material containing layer forming
coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| LiNd0.9 Yb0.1 Mo4 012 powder (Average particle | 4 parts |
| diameter: 0.5 μm) | |
| Phenol-resin [Tamanoru 521: manufactured by Arakawa- | 4 parts |
| Chemical-Industries, Ltd.] | |
| Methyl ethyl ketone | 90 parts |

<a face image recording layer or a personal information recording material 4>

An ink sheet including a face image recording layer or personal information recording layer production material was obtained in such a way that an yellow ink layer forming coating liquid, a magenta ink layer forming coating liquid, and a cyan ink layer forming coating liquid, a falsification and modification preventing yellow ink layer forming coating liquid 2, a falsification and modification preventing magenta ink layer forming coating liquid 2, a falsification and modification preventing cyan ink layer forming coating liquid 2, and a black layer forming coating liquid having the following respective compositions were provided in the surface order shown in the embodiment of FIG. 3(h) to make respective thickness to be 1 μm on a polyethylene terephthalate sheet which has a thickness of 6 μm and was subjected to a fusion-prevention processing on its reverse side. Incidentally, P section given in FIG. 3(h) is a layer prepared in order to carry out after-heating, and represents a part for a non-coated portion in the present invention. A face image recording layer or a personal information recording material can be formed by the recording unit 31 of the issuing apparatus of FIG. 22 and FIG. 23 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Yellow ink layer forming coating liquid 2>
Yellow dye

| | | |
|---|---|---|
| Compound Y-2 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyrene | 1 | parts |
| [REDEDA GP-200: manufactured by | | |
| Toagosei Chemical-industry Co., Ltd.] | | |
| Urethane denaturation silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid 2>
Magenta dye

| | | |
|---|---|---|
| Compound M-2 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| Methyl ethyl ketone | 70 | parts |
| Toluene | 20 | parts |

<Cyan ink layer forming coating liquid 2>
Cyan dye

| | | |
|---|---|---|
| Compound C-2 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane denaturation silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

<A face image recording layer or a personal information recording material 5>

An ink sheet including a face image recording layer or personal information recording layer production material 5 was obtained in such a way that an yellow ink layer forming coating liquid, a magenta ink layer forming coating liquid, and a cyan ink layer forming coating liquid, a black layer forming coating liquid having the following respective compositions were provided in the surface order shown in the embodiment of FIG. 2(a) to make respective thickness to be 1 μm on a polyethylene terephthalate sheet which has a thickness of 6 μm and was subjected to a fusion prevention processing on its reverse side, further, a face image recording layer or a personal information recoding material 7 were obtained b y providing a adhesive layer in the similar surface order. Incidentally, P section given in FIG. 2(a) is a layer prepared in order to carry out after-heating, and represents a part for a non-coated portion in the present invention. A face image recording layer or a personal information recording material can be formed by the recording unit 31 of the issuing apparatus of FIG. 18 and FIG. 21 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<The coating liquid for cyan ink stratification>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

(Production of an ink sheet structured by an authentication recording-medium paper substrate adhesive layer)

A release layer of 0.1 g/m² and a adhesive layer for an authentication recording-medium paper substrates of 10 μm were coated in this order.

(Formation of a release layer)

Flouroresin

<An authentication recording-medium paper substrate adhesive layer forming coating liquid>

| | | |
|---|---|---|
| Esdyne 580G (made by SEKISUI CHEMICAL Co., LTD.) | 9.5 | parts |
| Hardener Collo Nate L (made by Japanese polyurethane | 0.5 | parts |
| company) | | |
| Toluene | 10 | parts |

<A face image recording layer or a personal information recording material 6>

An ink sheet including a face image recording layer or personal information recording layer production material 5 was obtained in such a way that an yellow ink layer forming coating liquid, a magenta ink layer forming coating liquid, and a cyan ink layer forming coating liquid, a falsification and modification preventing yellow ink layer forming coating liquid 2, a falsification and modification preventing magenta ink layer forming coating liquid 2, a falsification and modification preventing cyan ink layer forming coating liquid 2, and a black layer forming coating liquid having the following respective compositions were provided in the surface order shown in the embodiment of FIG. 2(h) to make respective thickness to be 1 μm on a polyethylene terephthalate sheet which has a thickness of 6 μm and was subjected to a fusion prevention processing on its reverse side, further, a face image recording layer or a personal information recoding material were obtained by providing a adhesive layer in the similar surface order. Incidentally, P section given in FIG. 2(h) is a layer prepared in order to carry out after-heating, and represents a part for a non-coated portion in the present invention. A face image recording layer or a personal information recording material can be formed by the recording unit 31 of the issuing apparatus of FIG. 18 and FIG. 21 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Yellow ink layer forming coating liquid 2>
Yellow dye

| | | |
|---|---|---|
| Compound Y-2 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid 2>
Magenta dye

| | | |
|---|---|---|
| Compound M-2 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid 2>
Cyan dye

| | | |
|---|---|---|
| Compound C-2 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

(Production of an ink sheet structured by an authentication recording-medium paper substrate adhesive layer)

release layer of 0.1 g/m² and a adhesive layer for an authentication recording-medium paper substrates of 10 μ, were coated in this order.

(Formation of a release layer)

| | | |
|---|---|---|
| Paraffin wax | 5 | parts |
| Ester wax | 5 | parts |
| Toluene | 1000 | parts |

<An authentication recording-medium paper substrate
adhesive layer forming coating liquid>
(Photo-curing type adhesive)

| | | |
|---|---|---|
| SEROKISIDE 2021 (manufactured by Daicel Chemical | 3.0 | parts |
| Industries, Ltd., Epoxy equivalents 128-140) | | |
| EPO-light 3002 (manufactured by Kyoeisha chemistry Co., | 2.5 | parts |
| Ltd.) | | |
| EPI-coat #828 (made by Yuka shell epoxy company, epoxy | 3.0 | parts |
| equivalents 184-194) | | |
| optical cation generating compound: TPS-1 (manufactured | 0.5 | parts |
| by Midori chemistry Co., Ltd.) | | |
| EPO-friend CT310 (manufactured by Daicel Chemical | 1.0 | parts |
| Industries, Ltd.) | | |
| Toluene | 100 | parts |

<A face image recording layer or a personal information recording material 7>

An ink sheet including a face image recording layer or personal information recording layer production material 5 was obtained in such a way that an yellow ink layer forming coating liquid, a magenta ink layer forming coating liquid, and a cyan ink layer forming coating liquid, and a black layer forming coating liquid having the following respective compositions were provided in the surface order shown in the embodiment of FIG. 2(a) to make respective thickness to be 1 μm on a polyethylene terephthalate sheet which has a thickness of 6 μm and was subjected to a fusion prevention processing on its reverse side, further, a face image recording layer or a personal information recoding material 7 were obtained by providing a adhesive layer in the similar surface order. Incidentally, P section given in FIG. 2(a) is a layer prepared in order to carry out after-heating, and represents a part for a non-coated portion in the present invention. A face image recording layer or a personal information recording material can be formed by the recording unit 31 of the issuing apparatus of FIG. 18 and FIG. 21 for a personal information recording layer or a face image recording layer.

(Production of a Sublime Type Thermal Transfer Recording Material)

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| rethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: manufactured by Mitsui E. I. du Pont de Nemours | |
| Chemical Co., Ltd.] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

(Production of an Ink Sheet Structured by an Authentication Recording-Medium Paper Substrate Adhesive Layer)

A release layer of 0.1 g/m² and a adhesive layer for an authentication recording-medium paper substrates of 10 μm were coated in this order.

(Formation of a release layer)

Fluororesin

<An authentication recording-medium paper substrate adhesive layer forming coating liquid>

| | | |
|---|---|---|
| Esdyne 580G (made by SEKISUI CHEMICAL Co., LTD.) | 9.5 | parts |
| Hardener Collo Nate L (made by Japanese polyurethane | 0.5 | parts |
| company) | | |
| Toluene | 10 | parts |

(Method of producing a substrate adhesive material for an auhentication recording media)

<An Authentication Recording Media Substrate Adhesive Material Sheet 1>

An authentication recording media substrate adhesive material sheet was obtained in such a way that the following compositions were coated sequentially as shown in the embodiment of FIG. 4 on a polyethylene terephthalate sheet which has a thickness of 6 μm and were subjected to a fusion prevention processing on its reverse side. An authentication recording media substrate adhesive can be used with an authentication recording media paper substrate adhesive layer providing unit 91 of an issuing apparatus of FIG. 22 and FIG. 23.

A release layer of 0.1 g/m² and a adhesive layer for an authentication recording-medium paper substrates of 10 μm were coated in this order.

(Formation of a Release Layer)

Fluororesin

<An authentication recording-medium paper substrate adhesive layer forming coating liquid>

| | |
|---|---|
| Esdyne 580G (made by SEKISUI CHEMICAL Co., LTD.) | 9.5 parts |
| Hardener Collo Nate L (made by Japanese polyurethane | 0.5 parts |
| company) | |
| Toluene | 10 parts |

<An authentication recording media substrate adhesive material sheet 2>

An authentication recording media substrate adhesive material sheet was obtained in such a way that the following compositions were coated sequentially as shown in the embodiment of FIG. 4 on a polyethylene terephthalate sheet which has a thickness of 6 μm and were subjected to a fusion prevention processing on its reverse side.

A release layer of 0.1 g/m² and a adhesive layer for an authentication recording-medium paper substrates of 10 μm were coated in this order.

(Formation of a Release Layer)

Fluororesin

<An authentication recording-medium paper substrate adhesive layer forming coating liquid>

(Photo-curing type adhesive)

| | |
|---|---|
| SEROKISIDE 2021 (manufactured by Daicel Chemical | 3.0 parts |
| Industries, Ltd., Epoxy equivalents 128-140) | |
| EPO-light 3002 (manufactured by Kyoeisha chemistry Co., | 2.5 parts |
| Ltd.) | |
| EPI-coat #828 (made by Yuka shell epoxy company, epoxy | 3.0 Parts |
| equivalents 184-194) | |
| Optical cation generating compound: TPS-1 (manufactured | 0.5 parts |
| by Midori chemistry Co., Ltd.) | |
| EPO-friend CT310 (manufactured by Daicel Chemical | 1.0 parts |
| Industries, Ltd.) | |
| Toluene | 100 parts |

<An authentication recording media substrate adhesive material sheet 3>

An authentication recording media substrate adhesive material sheet was obtained in such a way that the following compositions were coated sequentially as shown in the embodiment of FIG. 4 on a polyethylene terephthalate sheet which has a thickness of 6 μm and were subjected to a fusion prevention processing on its reverse side.

A release layer of 0.1 g/m² and a adhesive layer for an authentication recording-medium paper substrates of 10 μm were coated in this order.

(Formation of a Release Layer)

Fluororesin

| | | |
|---|---|---|
| Esdyne 580G (made by SEKISUI CHEMICAL Co., LTD.) | 9.5 | parts |
| Hardener Collo Nate L (made by Japanese polyurethane | 0.5 | parts |
| company) | | |
| Toluene | 10 | parts |

<An Authentication Recording Media Substrate Adhesive Material Sheet 4>

An authentication recording media substrate adhesive material sheet was obtained in such a way that the following compositions were coated sequentially as shown in the embodiment of FIG. 4 on a polyethylene terephthalate sheet which has a thickness of 6 μm and were subjected to a fusion prevention processing on its reverse side.

A release layer of 0.1 g/m² and a adhesive layer for an authentication recording-medium paper substrates of 10 μm were coated in this order.

(Formation of a Release Layer)

Fluororesin

<An authentication recording-medium paper substrate adhesive layer forming coating liquid>

| | |
|---|---|
| Esdyne 580G (made by SEKISUI CHEMICAL Co., LTD.) | 9.5 parts |
| Hardener Collo Nate L (made by Japanese polyurethane | 0.5 parts |
| company) | |
| Toluene | 10 parts |

(Image-receiving sheet production method)

<Image-receiving sheet 1>

An image receiving sheet was obtained in such a way that the following compositions were coated sequentially as shown in the embodiment of FIGS. 5(a) to 5(c) on a polyethylene terephthalate sheet which has a thickness of 6 μm and were subjected to a fusion prevention processing on its reverse side.

An image-receiving sheet can be used with an image-receiving sheet transfer units 41 and 71 of an issuing apparatus of FIG. 18 to FIG. 23.

| | | |
|---|---|---|
| <First image receiving layer forming coating liquid> | 2.5 | μm |
| Polyvinyl-butyral resin | 6 | parts |
| [Esreck BX-l: manufactured by | | |
| SEKISUI CHEMICAL Co., LTD.] | | |
| Metal ion containing compound (compound MS) | 4 | parts |
| Methyl ethyl ketone | 80 | parts |
| Butyl acetate | 10 | parts |
| <Second image receiving layer forming coating liquid> | 0.5 | μm |
| Polyethylene wax | 2 | parts |
| [High-tech E1000: manufactured by Toho Chemical | | |
| Industry Co., Ltd.] | | |
| Urethane modified ethylene acrylic acid copolymer | 8 | parts |
| [High-tech S6254: manufactured by Toho Chemical | | |
| Industry Co., Ltd.] | | |
| Methyl-cellulose [SM15: manufactured by Shin-Etsu | 0.1 | parts |
| Chemical Co., Ltd.] | | |
| Water | 90 | parts |

<Image-receiving sheet 2>

A sand matte processing process was performed with silica sand for a Tetoron G2P8-25 micron PET manufactured by Teijin E. I. du Pont de Nemours& Co. so that its antistatic reverse side has a center line average roughness (Ra) of 0.4 μm. Coating liquids of the following compositions were laminated one by one so that coating layers were formed on the antistatic coating side shown in the embodiment of FIG. 5(b) and an image-receiving sheet was obtained. An image-receiving sheet can be used with the image-receiving sheet transfer units 41 and 71 of the issuing apparatus of FIG. 18 to FIG. 23.

| | | |
|---|---|---|
| (Releasing layer forming coating liquid) | 0.2 | μm of layer thickness |
| Polyvinyl alcohol (GL-05) (manufactured | 10 | parts |
| by Japanese synthetic chemistry) | | |
| Water | 90 | parts |

The releasing layer was coated under a drying condition of 90° C./30 sec.

| | | |
|---|---|---|
| (Actinic radiation hardenable compound) | 7.0 | μm of layer thickness |

A-9300 manufactured by Shin-Nakamura chemistry company/EA-1020
manufactured by Shin-Nakamura chemistry company = 35/11.75 parts
Reaction initiator

| | | |
|---|---|---|
| Irgacure 184 manufactured by Ciba-Geigy | 5 | parts |
| Japan | | |
| Transfer foil-use resin 1 (described below) | 48 | parts |
| Surfactant F-179 manufactured by | 0.25 | parts |
| Dainippon Ink | | |
| Toluene | 500 | parts |

After coating, the actinic radiation hardenable compound was dried under 90° C./30 sec and, subsequently photo-curing was conducted for it with a mercury-vapor lamp (300 mJ/cm2).

| | | |
|---|---|---|
| <Intermediate layer forming coating liquid> | 1.0 | μm of layer thickness |
| Polyvinyl butyral resin [Esreck BX-l: | 3.5 | parts |
| manufactured by Sekisui Chemical Co., Ltd.] | | |
| Tough tex M-1913 (Asahi Kasei | 5 | parts |
| Corporation) | | |
| Hardener Polyisocyanate [Coronate HX: | 1.5 | parts |
| manufactured by Nippon Polyurethane] | | |
| Methyl ethyl ketone | 90 | parts |

After coating, Hardening for the hardening agent was carried out under
50° C., 24 hours.

| | | |
|---|---|---|
| <Adhesive layer forming coating liquid> | 0.5 | μm of layer thickness |
| Urethane modified ethylene ethyl acrylate | 8 | parts |
| copolymer [high-tech S6254B: manufactured | | |
| by Toho Chemical Industry Co., Ltd.] | | |
| Polyacrylic acid ester copolymer | 2 | parts |
| [Juli Maher AT510: manufactured by Nihon | | |
| Junyaku Co., Ltd.] | | |
| Water | 45 | parts |
| Ethanol | 45 | parts |

After coating, It was dried under 70° C./30 sec.

After coating, It was dried under 70° C./30 sec.

(Synthesis of the Resin 1 for Transfer Foil)

73 parts of meta-ethyl acrylate, 15 parts of benzyl meta-acrylate, 12 parts of meta-acrylic acid, 500 parts of ethanol and 3 parts of α, α′-azobisisobutyronitriles were put into a three-mouth flask under a nitrogen gas current, and were allowed to react for 6 hours with a 80° C. oil bath under a nitrogen gas current. Subsequently, 3 parts of triethyl ammonium chloride and 1.0 parts of glycidyl methacrylates were added, and the resultant compositions were allowed to react for 3 hours, and whereby a synthetic binder 1 of a target acrylics base copolymer was obtained. Mw.17000, an acid number 32

<Image-Receiving Sheet 3>

A sand matte processing process was performed with silica sand for a Tetoron G2P8-25 micron PET manufactured by Teijin E. I. du Pont de Nemours& Co. so that its antistatic reverse side has a center line average roughness (Ra) of 0.4 μm. Coating liquids of the following compositions were laminated one by one so that coating layers were formed on the antistatic coating side shown in the embodiment of FIG. 5(c) and an image-receiving sheet was obtained. An image-receiving sheet can be used with the image-receiving sheet transfer units 41 and 71 of the issuing apparatus of FIG. 18 to FIG. 23.

| | |
|---|---|
| (Releasing layer forming coating liquid) | 0.2 μm of layer thickness |
| Polyvinyl alcohol (GL-05) (manufactured by | 10 parts |
| Japanese synthetic chemistry) | |
| Water | 90 parts |

The releasing layer was coated under a drying condition of 90° C./30 sec.

| (Actinic radiation hardenable compound) | 7.0 μm of | |
|---|---|---|
| A-9300 manufactured by Shin-Nakamura chemistry | layer thickness | |
| company/EA-1020 manufactured by Shin-Nakamura | | |
| chemistry company = 35/11.75 parts | | |
| Reaction initiator | | |
| Irgacure 184 manufactured by Ciba-Geigy Japan | 5 | parts |
| Transfer foil-use resin 1 (described below) | 48 | parts |
| Surfactant F-179 manufactured by Dainippon Ink | 0.25 | parts |
| Toluene | 500 | parts |

After coating, the actinic radiation hardenable compound was dried under
90° C./30 sec and, subsequently photo-curing was conducted for it wih a
mercury-vapor lamp (300 mJ/cm2).

| (Volume type hologram forming layer) | 3.0 μm of | |
|---|---|---|
| A three-dimensional hologram layer was formed with a | layer thickness | |
| specific size on the above-mentioned actinic radiation | | |
| hardening layer. | | |
| <Intermediate layer forming coating liquid> | 1.0 μm of | |
| | layer thickness | |
| Polyvinyl butyral resin [Esreck BX-1: manufactured by | 3.5 | parts |
| Sekisui Chemical Co., Ltd.] | | |
| Tough tex M-1913 (Asahi Kasei Corporation) | 5 | parts |
| Hardener Polyisocyanate [Coronate HX: manufactured by | 1.5 | parts |
| Nippon Polyurethane] | | |
| Methyl ethyl ketone | 90 | parts |
| After coating, Hardening for the hardening agent was | | |
| carried out under 50 C, 24 hours. | | |
| <Adhesive layer forming coating liquid> | 0.5 μm of | |
| | layer thickness | |
| Urethane modified ethylene ethyl acrylate copolymer | 8 | parts |
| [High-tech S6254B: manufactured by Toho Chemical | | |
| Industry Co., Ltd.] | | |
| Polyacrylic acid ester copolymer [Juli Maher AT510: | 2 | parts |
| manufactured by Nihon Junyaku Co., Ltd.] | | |
| Water | 45 | parts |
| Ethanol | 45 | parts |

After coating, It was dried under 70° C./30 sec.

(Falsification and Modification Preventing Material Producing Method)

<Falsification and Modification Preventing Material 1>

An ink sheet structured by a falsification and modification preventing material was obtained in such a way that an yellow fluorescent pigment layer forming coating liquid, a magenta fluorescent pigment layer forming coating liquid, and a cyan fluorescent pigment layer forming coating liquid, and a black layer forming coating liquid having the following respective compositions were provided in the surface order shown in the embodiment of FIG. 7(a) to make respective thickness to be 1 μm on a polyethylene terephthalate sheet which has a thickness of 6 μm and was subjected to a fusion prevention processing on its reverse side. The falsification and modification preventing material can be used by the falsification and modification preventing layer recording unit 61 of the issuing apparatus of FIG. 22 and FIG. 23.

(Production of an Ink Sheet for a Melting Type Thermal Transfer Recording)

<Yellow fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Yellow fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Magenta fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Magenta fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Cyan fluorescent pigment>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Cyan fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

(Production of an ink sheet for a melting type of thermal transfer recording)

<Black layer forming coating liquid>

<Black layer forming coating liquid>

| | |
|---|---|
| Carnauba wax | 1 parts |
| Ethylene-vinyl acetate copolymer | 1 parts |
| [EV40Y: produced by Mitsui E. I. du Pont de Nemours | |
| Chemical] | |
| Carbon black | 3 parts |
| Phenol-resin [Tamanoru 521: manufactured by Arakawa- | 5 parts |
| Chemical-Industries, Ltd.] | |
| Methyl ethyl ketone | 90 parts |

<Falsification and modification preventing material 2>

A falsification and modification preventing material was obtained in such a way that an yellow fluorescent pigment layer forming coating liquid, a magenta fluorescent pigment layer forming coating liquid, and a cyan fluorescent pigment layer forming coating liquid, and a black layer forming coating liquid having the following respective compositions were provided to make respective thickness to be 1 μm and further a volume type hologram layer forming material was provided to make a thickness to be 3 μm in the surface order shown in the embodiment of FIG. 7(c) on a polyethylene terephthalate sheet which has a thickness of 6 μm and was subjected to a fusion prevention processing on its reverse side. An ink sheet was structured by the falsification and modification preventing material.

The falsification and modification preventing material can be used by the falsification and modification preventing layer recording unit 61 of the issuing apparatus of FIG. 22 and FIG. 23.

(Production of an Ink Sheet for a Melting Type Thermal Transfer Recording)

<Yellow fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Yellow fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Magenta fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Magenta fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Cyan fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Cyan fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: produced by Mitsui E. I. du Pont de Nemours | |
| Chemical] | |
| Carbon black | 3 parts |
| henol-resin [Tamanoru 521: manufactured by Arakawa- | 5 parts |
| Chemical-Industries, Ltd.] | |
| Methyl ethyl ketone | 90 parts |

<Falsification and modification preventing material 3>

An ink sheet structured by a falsification and modification preventing material was obtained in such a way that an yellow fluorescent pigment layer forming coating liquid, a magenta fluorescent pigment layer forming coating liquid, and a cyan fluorescent pigment layer forming coating liquid having the following respective compositions were provided in the surface order shown in the embodiment of FIG. 7(f) to make respective thickness to be 1 μm on a polyethylene terephthalate sheet which has a thickness of 6 μm and was subjected to a fusion prevention processing on its reverse side. The falsification and modification preventing material can be used by the falsification and modification preventing layer recording unit 61 of the issuing apparatus of FIG. 22 and FIG. 23.

(Production of an Ink Sheet for a Melting Type Thermal Transfer Recording)

<Yellow fluorescent pigment layer forming coating
liquid>

| | | |
|---|---|---|
| Carnauba wax | 1 | parts |
| Ethylene-vinyl acetate copolymer | 1 | parts |
| [EV40Y: produced by Mitsui E.I. du Pont de Nemours | | |
| Chemical] | | |
| Yellow fluorescent pigment FZ-2000 (made by Sinlohi) | 3 | parts |
| Phenol-resin [Tamanoru 521: manufactured by Arakawa- | 5 | parts |
| Chemical-Industries, Ltd.] | | |
| Methyl ethyl ketone | 90 | parts |

<Magenta fluorescent pigment layer forming coating
liquid>

| | | |
|---|---|---|
| Carnauba wax | 1 | parts |
| Ethylene-vinyl acetate copolymer | 1 | parts |
| [EV40Y: produced by Mitsui E.I. du Pont de Nemours | | |
| Chemical] | | |
| Magenta fluorescent pigment FZ-2000 (made by Sinlohi) | 3 | parts |
| Phenol-resin [Tamanoru 521: manufactured by Arakawa- | 5 | parts |
| Chemical-Industries, Ltd.] | | |
| Methyl ethyl ketone | 90 | parts |

<Cyan fluorescent pigment layer forming coating liquid>

| | | |
|---|---|---|
| Carnauba wax | 1 | parts |
| Ethylene-vinyl acetate copolymer | 1 | parts |
| [EV40Y: produced by Mitsui E.I. du Pont de Nemours | | |
| Chemical] | | |
| Cyan fluorescent pigment FZ-2000 (made by Sinlohi) | 3 | parts |
| Phenol-resin [Tamanoru 521: manufactured by Arakawa- | 5 | parts |
| Chemical-Industries, Ltd.] | | |
| Methyl ethyl ketone | 90 | parts |

<Falsification and modification preventing material 4>

An ink sheet structured by a falsification and modification preventing material was obtained in such a way that an yellow fluorescent pigment layer forming coating liquid, a magenta fluorescent pigment layer forming coating liquid, a cyan fluorescent pigment layer forming coating liquid and a black layer forming coating liquid having the following respective compositions were provided in the surface order shown in the embodiment of FIG. 6(a) to make respective thickness to be 1 μm and further an adhesive layer was provided on a polyethylene terephthalate sheet which has a thickness of 6 μm and was subjected to a fusion prevention processing on its reverse side. The falsification and modification preventing material can be used by the falsification and modification preventing layer recording unit 61 of the issuing apparatus of FIG. 18 and FIG. 21.

(Production of an Ink Sheet for a Melting Type Thermal Transfer Recording)

<Yellow fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Yellow fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Magenta fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Magenta fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Cyan fluorescent pigment layer forming coating liquied>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Cyan fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: produced by Mitsui E. I. du Pont de | |
| Nemours Chemical] | |
| Carbon black | 3 parts |
| Phenol-resin [Tamanoru 521: manufactured by | 5 parts |
| Arakawa-Chemical-Industries, Ltd.] | |
| Methyl ethyl ketone | 90 parts |

(Production of an Ink Sheet Structured by an Authentication Recording-Medium Paper Substrate Adhesive Layer)

A below-mentioned release layer of 0.1 g/m² and a adhesive layer for an authentication recording-medium paper substrates of 10 μm were coated in this order.

(Formation of a Release Layer)

Fluororesin

<An authentication recording-medium paper substrate adhesive layer forming coating liquid>

| | |
|---|---|
| Esdyne 580G (made by SEKISUI CHEMICAL Co., LTD.) | 9.5 parts |
| Hardener Collo Nate L (made by Japanese polyurethane | 0.5 parts |
| company) | |
| Toluene | 10 parts |

<Falsification and modification preventing material 5>

An ink sheet structured by a falsification and modification preventing material was obtained in such a way that an yellow fluorescent pigment layer forming coating liquid, a magenta fluorescent pigment layer forming coating liquid, a cyan fluorescent pigment layer forming coating liquid, an infrared absorption ink containing layer forming coating liquid, a pearl pigment containing ink layer forming coating liquid and a black layer forming coating liquid having the following respective compositions were provided in the surface order shown in the embodiment of FIG. 6(b) to make respective thickness to be 1 μm and further an adhesive layer was provided on a polyethylene terephthalate sheet which has a thickness of 6 μm and was subjected to a fusion prevention processing on its reverse side. The falsification and modification preventing material can be used by the falsification and modification preventing layer recording unit 61 of the issuing apparatus of FIG. 18 and FIG. 21.

(Production of an Ink Sheet for a Melting Type Thermal Transfer Recording)

<Yellow fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Yellow fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Magenta fluorescent pigment layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Magenta fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Cyan fluorescent pigment layer forming coating liquid>

| | | |
|---|---|---|
| arnauba wax | 1 | parts |
| Ethylene-vinyl acetate copolymer | 1 | parts |
| [EV40Y: produced by | | |
| Mitsui E. I. du Pont de Nemours Chemical] | | |
| Cyan fluorescent pigment FZ-2000 | 3 | parts |
| (made by Sinlohi) | | |
| Phenol-resin [Tamanoru 521: manufactured by | 5 | parts |
| Arakawa-Chemical-Industries, Ltd.] | | |
| Methyl ethyl ketone | 90 | parts |

<Infrared absorption agent containing layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| LiNd0.9 Yb0.1 Mo4 012 powder | 4 | parts |
| (Average particle diameter: 0.5 μm) | | |
| Phenol-resin [Tamanoru 521: manufactured by | 5 | parts |
| Arakawa-Chemical-Industries, Ltd.] | | |
| Methyl ethyl ketone | 90 | parts |

<Pearl containing layer forming coating liquid>

| | | |
|---|---|---|
| Carnauba wax | 1 | parts |
| Ethylene-vinyl acetate copolymer | 1 | parts |
| [EV40Y: produced by | | |
| Mitsui E. I. du Pont de Nemours Chemical] | | |
| Pearl pigment Iriodin211 (made by Merck Co.) | 3 | parts |
| Phenol-resin [Tamanoru 521: manufactured by | 5 | parts |
| Arakawa-Chemical-Industries, Ltd.] | | |
| Methyl ethyl ketone | 90 | parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: produced by Mitsui E. I. du Pont de | |
| Nemours Chemical] | |
| Carbon black | 3 parts |
| Phenol-resin [Tamanoru 521: manufactured by | 5 parts |
| Arakawa-Chemical-Industries, Ltd.] | |
| Methyl ethyl ketone | 90 parts |

(Production of an ink sheet structured by an authentication recording-medium paper substrate adhesive layer)

A below-mentioned release layer of 0.1 g/m² and a adhesive layer for an authentication recording-medium paper substrates of 10 μm were coated in this order.

(Formation of a release layer)

Fluororesin

<An authentication recording-medium paper substrate adhesive layer forming coating liquid>

| | |
|---|---|
| Esdyne 580G (made by SEKISUI CHEMICAL Co., LTD.) | 9.5 parts |
| Hardener Collo Nate L (made by Japanese polyurethane | 0.5 parts |
| company) | |
| Toluene | 10 parts |

<Falsification and modification preventing material 6>

An ink sheet structured by a falsification and modification preventing material was obtained in such a way that a falsification and modification preventing yellow ink layer forming coating liquid, a falsification and modification preventing magenta ink layer forming coating liquid, a falsification and modification preventing cyan ink layer forming coating liquid, a magenta fluorescent pigment layer forming coating liquid, an infrared absorption ink containing layer forming coating liquid, and a black layer forming coating liquid having the following respective compositions were provided in the surface order shown in the embodiment of FIG. 6(g) to make respective thickness to be 1 μm and further an adhesive layer was provided on a polyethylene terephthalate sheet which has a thickness of 6 μm and was subjected to a fusion prevention processing on its reverse side. Incidentally, P section given in FIG. 6(g) is a layer prepared in order to carry out after-heating, and represents a part for a non-coating portion in this invention. The falsification and modification preventing material can be used by the falsification and modification preventing layer recording unit 61 of the issuing apparatus of FIG. 18 and FIG. 21.

<Yellow ink layer forming coating liquid>
Yellow dye

| | | |
|---|---|---|
| Compound Y-1 | 3 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Magenta ink layer forming coating liquid>
Magenta dye

| | | |
|---|---|---|
| Compound M-1 | 2 | parts |
| Polyvinyl acetal | 5.5 | parts |
| [Denka butyral KY-24: manufactured by | | |
| DENKIKAGAKU-KOGYO-KABUSHIKI-KAISHA] | | |
| Polymethyl metaacrylate modified polystyre | 2 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

<Cyan ink layer forming coating liquid>
Cyan dye

| | | |
|---|---|---|
| Compound C-1 | 3 | parts |
| Polyvinyl acetal | 5.6 | parts |
| [Denka butyral KY-24: manufactured by | | |
| DENKIKAGAKU-KOGYO-KABUSHIKI-KAISHA] | | |
| Polymethyl metaacrylate modified polystyre | 1 | parts |
| [REDEDA GP-200: manufactured by | | |
| Toagosei Chemical-industry Co., Ltd.] | | |
| Urethane modified silicone oil | 0.5 | parts |
| [DiaromaSP-2105: manufactured by | | |
| Dainichiseika Industry Co., Ltd.] | | |
| Methyl ethyl ketone | 70 | parts |
| Toluene | 20 | parts |

(Productio of an ink sheet for a melting type thermal transfer recording)

<Magenta fluorescent pigment layer forming coating liquid>

| | |
|---|---|
| Carnauba wax | 1 parts |
| Ethylene-vinyl acetate copolymer | 1 parts |
| [EV40Y: produced by Mitsui E. I. du | |
| Pont de Nemours Chemical] | |
| Magenta fluorescent pigment FZ-2000 (made by Sinlohi) | 3 parts |
| Phenol-resin [Tamanoru 521: manufactured by Arakawa- | 5 parts |
| Chemical-Industries, Ltd.] | |
| Methyl ethyl ketone | 90 parts |
| <Infrared absorption agent containing layer forming | |
| coating liquid> | |
| Carnauba wax | 1 parts |
| Ethylene-vinyl acetate copolymer | 1 parts |
| [EV40Y: produced by Mitsui E. I. du | |
| Pont de Nemours Chemical] | |
| LiNd0.9 Yb0.1 Mo4 012 powder. (Average particle | 4 parts |
| diameter: 0.5 μm) | |
| Phenol-resin [Tamanoru 521: manufactured by Arakawa- | 4 parts |
| Chemical-Industries, Ltd.] | |
| Methyl ethyl ketone | 90 parts |

(Production of an ink sheet for a melting type thermal transfer recording)

<Black layer forming coating liquid>

| | |
|---|---|
| Carnauba wax | 1 parts |
| Ethylene-vinyl acetate copolymer | 1 parts |
| [EV40Y: produced by Mitsui E. I. du Pont | |
| de Nemours Chemical] | |
| Carbon black | 3 parts |
| Phenol-resin [Tamanoru 521: manufactured by | 5 parts |
| Arakawa-Chemical-Industries, Ltd.] | |
| Methyl ethyl ketone | 90 parts |

(Production of an ink sheet structured by an authentication recording-medium paper substrate adhesive layer)

A below-mentioned release layer of 0.1 g/m² and a adhesive layer for an authentication recording-medium paper substrates of 10 μm were coated in this order.

(Formation of a Release Layer)

Fluororesin

<An authentication recording-medium paper substrate adhesive layer forming coating liquid>

| | |
|---|---|
| Esdyne 580G (made by SEKISUI CHEMICAL Co., LTD.) | 9.5 parts |
| Hardener Collo Nate L (made by Japanese polyurethane | 0.5 parts |
| company) | |
| Toluene | 10 parts |

Samples were produced by the issuing apparatus of FIG. 18 to FIG. 23 with the forming materials in FIG. 2(a) FIG. to FIG. 2(h), FIG. 3(a) to FIG. 3(h), FIG. 4, FIG. 5(a) to FIG. 5(c), FIG. 6(a) to FIG. 6(g), FIG. 7(a) to FIG. 7(g). Concrete production conditions are shown below.

(A Personal Information Recording Layer or a Face Image Recording Layer Forming Method)

In a recording unit 31 of a personal information recording layer or a face image recording layer, an ink side of a surface sequential sheet of a face image recording layer or personal information recording layer forming material 1 was piled up, and was heated from the ink sheet side by the use of a thermal head 51 on the condition of an output of 0.5 W/dot, a pulse width of 1.0 m seconds, and a dot density of 16 dots/mm, whereby a portrait image with a gradation and personal information were formed on an image-receiving sheet.

[Image-Receiving Sheet Transfer Forming Method]

It comprises a process to transfer an image-receiving sheet formed by the recording unit 31 on an authentication recording-medium paper substrate.

A heat roll section 47 of the image-receiving sheet transfer unit 41 conducted transferring an image receiving sheet formed by the recording unit 31 by applying heat for 1.2 seconds with a pressure of 150 kg/cm2 by the use of a heat roller which had a diameter of 5 cm and a rubber hardness of 85 and was heated to a surface temperature of 200 C.

[A Falsification and Modification Preventing Material Forming Method]

In a recording unit 61 of a personal information recording layer or a face image recording layer, an ink side of a surface sequential sheet of a falsification and modification preventing material 1 was piled up, and was heated from the ink sheet side by the use of a thermal head 81 on the condition of an output of 0.5 W/dot, a pulse width of 1.0 m seconds, and a dot density of 16 dots/mm, whereby information including personal information and a specific mark were formed on an image-receiving sheet.

(Image-Receiving Sheet Transfer Forming Method)

It comprises a process to transfer an image-receiving sheet formed by the recording unit 61 on an authentication recording-medium paper substrate.

A heat roll section 77 of the image-receiving sheet transfer unit 71 conducted transfering an image receiving sheet formed by the recording unit 61 by applying heat for 1.2 seconds with a pressure of 150 kg/cm2 by the use of a heat roller which had a diameter of 5 cm and a rubber hardness of 85 and was heated to a surface temperature of 200 C.

(An Authentication Recording-Medium Paper Substrate Adhesive Layer Forming Method)

In a providing unit 91 for an authentication recording-medium paper substrate adhesive layer, an ink side of an authentication recording-medium paper substrate adhesive layer material was piled up, and was heated from the ink sheet side by the use of a thermal head 101 on the condition of an output of 0.5 W/dot, a pulse width of 1.0 m seconds, and a dot density of 16 dots/mm, whereby a portrait image with a gradation and personal information on an image-receiving sheet and information including personal information and a specific mark were formed on an image-receiving sheet. In this invention, when an optical adhesive is used as an authentication recording-medium paper substrate adhesive layer material, before an image receiving sheet was transferred onto an intermediate transfer medium of an authentication recording-medium paper substrate adhesive layer material or an authentication recording-medium paper substrate adhesive layer material on which a portrait image with a gradation and personal information were formed, it was exposed with an exposure of 200 mj at a metal halide irradiating section 401.

Evaluation of an authentication recording-medium sample produced by this invention, each material used in the production process, and an issuing apparatus used for producing samples, and a produced authentication recording medium are shown in a Table 1.

TABLE 1

| | | First transfer process | | | | | |
|---|---|---|---|---|---|---|---|
| | | Face image | Authentication | | | | |
| | | recording | recording- | Light | | | |
| | | layer or | medium paper | scattering | | | |
| | Substrate for | personal | substrate | preventing | | Second transfer | |
| | an | information | adhesive layer | layer | | process | |
| | authentication | recording | (light | (adhesive | First | Falsification | |
| | recording- | layer | scattering | layer) | image | preventing | |
| Sample | medium | forming | preventing | thickness | receiving | layer forming | Second |
| No. | (Ra value) | material | layer) material | (μm) | sheet | material | sheet |
| 1 | 1 (50 μm) | 1 | 1 | 10 | 1 | 1 | 3* |
| 2 | 1 (50 μm) | 2 | 2 | 10 | 1 | 2* | 2 |
| 3 | 1 (50 μm) | 3 | 3 | 0.2 | 1 | 3 | 3* |
| 4 | 1 (50 μm) | 3 | 1 | 10 | 1 | 3 | 3* |
| 5 | 1 (50 μm) | 3 | 2 | 10 | 1 | 3 | 3* |
| 6 | 1 (50 μm) | 4 | 2 | 10 | 1 | 1 | 3* |
| 7 | 1 (50 μm) | 5 | — | 10 | 1 | 4 | 3* |
| 8 | 1 (50 μm) | 6 | — | 10 | 1 | 5 | 3* |
| 9 | 1 (50 μm) | 7 | — | 0.2 | 1 | 4 | 3* |
| 10 | 2 (100 μm) | 5 | — | 10 | 1 | 6 | 3* |
| 11 | 3 (0.2 μm) | 5 | — | 10 | 1 | 6 | 3* |
| 12 | 4 (5 μm) | 2 | 1 | 10 | 1 | 2* | 2 |
| 13 | 4 (5 μm) | 2 | 2 | 10 | 1 | 2* | 2 |
| 14 | 4 (5 μm) | 2 | 4 | 80 | 1 | 2* | 2 |
| 15 | 4 (5 μm) | 2 | 4 | 80 | 1 | 2* | 2 |
| 16 | 4 (5 μm) | 2 | 3 | 0.2 | 1 | 2* | 2 |
| 17 | 3 (0.2 μm) | 2 | 3 | 0.2 | 1 | 2* | 2 |
| 18 | 2 (100 μm) | 2 | 3 | 0.2 | 1 | 2* | 2 |
| 19 | 2 (100 μm) | 2 | 4 | 80 | 1 | 2* | 2 |

| | | Evaluation | | | |
|---|---|---|---|---|---|
| | | | Falsification | | |
| | | | and | Falsification | |
| | | | modification | and | |
| | | | preventing | modification | |
| | Issuing | | ability | preventing | |
| | apparatus | | evaluation 1 | ability | |
| | used for | Tape | (discrimination | evaluation 1 | |
| Sample | producing | peeling | of a hidden | (appearance | |
| No. | samples | property | character) | of hologram) | Remarks |
| 1 | | 10 | — | A | Inv. |
| 2 | | 10 | — | A | Inv. |
| 3 | | 0 | — | C | Comp. |
| 4 | | 10 | — | A | Inv. |
| 5 | | 10 | — | A | Inv. |
| 6 | | 10 | A | A | Inv. |
| 7 | | 10 | — | A | Inv. |
| 8 | | 10 | A | A | Inv. |
| 9 | | 0 | — | C | Comp. |
| 10 | | 2 | A | C | Comp. |
| 11 | | 0 | A | A | Comp. |
| 12 | | 10 | — | A | Inv. |
| 13 | | 10 | — | A | Inv. |
| 14 | | 10 | — | AA | Inv. |
| 15 | | 10 | — | A | Inv. |
| 16 | | 4 | — | C | Comp. |
| 17 | | 6 | — | B | Comp. |
| 18 | | 0 | — | C | Comp. |
| 19 | | 0 | — | A | Comp. |

Mark * represents that there is a hologram layer.

Evaluating method for an authentication recording medium is shown below.

<Evaluation of Tape Peeling>

After sticking strongly a cellophane sticky tape (manufactured by Nichiban) on the surface of a hardened protective layer and peeling the cellophane sticky tape from the surface quickly, the peeling state was evaluated by grid pattern (cross cut) tape method defined by JIS K-5400. For an IC card, the-above-mentioned evaluation was carried out in such a way that a tape was attached to a card surface where a chip section was located.

The surface of a protective layer was cut in to reach a base at an angle of 30 with a sharp edged tool, such as a knife so as to form a grid pattern of 100 squares (1 mm or 1.5 mm, 10×10), and the number of squares of the coating which remained without peeling at this time was measured. In the case that the coating has good adhesion property on the whole, after making the grid pattern, a cellophane tape (registered trademark) was stuck on the surface of the grid pattern and then the tape was peeled, and thereafter the part in a thickness direction at which squares were peeled and the number of peeled squares were measured and evaluated. Evaluation was performed with the following evaluation score system.

Evaluation score of a cross cut test

Evaluation score: State of cut portions

10: Every one cut is thin, both sides of a cut are smooth, and every square at each cross cut was not peeled.

8: Slight peeling was observed at cross sections, there was no peeled square and the area of damaged sections was less than 5% of the total square area.

6: Peeling was observed in both sides of cuts and cross sections, and the area of damaged sections was 5% to 15% of the total square area.

4: A width of peeling by cut was wide and the area of damaged sections was 15% to 35% of the total square area.

2: A width of peeling by cut was wider than four squares, and the area of damaged sections was 35% to 65% of the total square area.

0: The area of peeling is 65% or more of the total square area.

<Evaluation 1 of Falsification Prevention Discriminating Capability>

According to an authentication recording medium discriminating method to discriminate a falsification preventing authentication recording medium formed by a second sublimation dye having an absorption wavelength different from a first sublimation dye by reading a portion of the different absorption wavelength, how to write a hidden character was discriminated and evaluated.

A: Discrimination is possible

B: Distinction is possible partially

C: Discrimination is impossible

<Evaluation 2 of Falsification Prevention Discriminating Capability>

The appearance of the hologram layer formed on the authentication recording medium was evaluated.

A: Discrimination is possible

B: Distinction is possible partially

C: Discrimination is impossible

As shown in Table 1, it can be seen that an authentication recording medium in which on a substrate of the authentication recording medium having an center-line-average-roughness (Ra) of 0.5-80.0 μm there was provided a substrate light scattering prevention layer with a thickness of 0.3-100 μm and further provided a hologram layer thereon is excellent in evaluation of tape fissility (adhesion) and an anti-falsification. When a substrate for an authentication recording media having a center line average roughness (Ra) of 0.5 μm or less or 80 μm or more was used, it can be seen that adhesion ability deteriorates. Even if a center line average roughness (Ra) is 0.5-80.0 μm, when the thickness of a light-scattering prevention layer (adhesive layer) is 0.3 or less, it can be seen that an adhesion ability and an appearance of a hologram deteriorates remarkably.

### INDUSTRIAL AVAILABILITY

As described above, the invention described in claim 1 to claim 12 can provide an authentication recording medium with which a hologram appearance is not spoiled, an adhesion ability with a hologram can be made excellent, and falsification and modification become very difficult.

1. An authentication recording-medium, comprising:
a substrate for the authentication recording-medium having a center line average roughness (Ra) of 0.5 to 80.0 μm:
a substrate light scattering preventing layer provide on the substrate; and
a hologram provided on the substrate light scattering preventing layer.

2. The authentication recording-medium described in claim 1, characterized in that a face image recording layer or a personal information recording layer is formed on the substrate for the authentication recording-medium, the substrate light scattering preventing layer is provide on the face image recording layer or the personal information recording layer, and the hologram is provided on the substrate light scattering preventing layer.

3. The authentication recording-medium described in claim 2, characterized in that the face image recording layer or the personal information recording layer is formed by-one of a) a sublimation recording method, b) a melt recording method, and c) a retransfer recording method.

4. The authentication recording-medium described in claim 2, characterized in that the face image recording layer or the personal information recording layer is formed by the sublimation recording method.

5. The authentication recording-medium described in claim 4, characterized in that in the sublimation recording method, two or more kinds of sublimation dyes having respective different wavelengths are used.

6. An authentication recording-medium producing method, comprising:
a recording layer producing process of forming a face image recording layer or a personal information recording layer on a first image receiving sheet with at least one of a) a sublimation recording method, b)-melt recording method, and c) retransfer recording method;
a substrate scattering preventing process of providing a substrate light scattering preventing layer having a thickness of 0.3 to 100 μm;
a transferring process of transferring the face image recording layer or the personal information recording layer and the substrate light scattering preventing layer formed on the first image receiving sheet onto a substrate of an authentication recording-medium having a center line average roughness (Ra) of 0.5 to 80.0 μm, and a process of forming a hologram on the substrate of the authentication recording-medium.

7. The authentication recording-medium producing method described in claim 6, characterized in that the process of forming a hologram comprises a second transferring process of transferring the hologram from a second image receiving sheet having the hologram to the substrate of the authentication recording-medium.

8. The authentication recording-medium producing method described in claim 6, characterized in that the process of forming a hologram comprises a process of forming the hologram on a second image receiving sheet, and a second transferring process of transferring the hologram recorded and formed on the second image receiving sheet having the hologram to the substrate of the authentication recording-medium.

9. The authentication recording-medium producing method described in claim 6, characterized in that the second transferring process comprises a recording process of recording arbitrary information on the second image receiving sheet by the use of a recording material of any one or more of a) a sublimation dye, b) a meltable ink, c) a fluorescent agent, e) an infrared absorbing material, f) a pearl pigment containing layer, or g) an optical change element; an adhesive layer forming process of forming an adhesive layer, a process of transferring information and the adhesive layer recorded and formed on the second image receiving sheet onto a substrate of the authentication recording-medium.

10. The authentication recording-medium producing method described in claim 8, characterized in that the second image receiving sheet includes a photo-curable layer.

11. The authentication recording-medium producing method described in claim 9, characterized in that the recording material contains a metal ion containing composition to form chelate by reacting with thermal-diffusable dye.

12. The authentication recording-medium producing method described in claim 1, characterized in that the substrate for an authentication recording-medium is a paper substrate.
